(19) United States
(12) Patent Application Publication
(10) Pub. No.: US 2016/0059960 A1
(43) Pub. Date: Mar. 3, 2016

(54) SEMI-AUTOMATIC COLLECTIVE PITCH MECHANISM FOR A ROTORCRAFT

(71) Applicants: Michael FEARN, Wellington (NZ); Brian FEARN, Derbyshire (GB)

(72) Inventors: Michael FEARN, Wellington (NZ); Brian FEARN, Derbyshire (GB)

(21) Appl. No.: 14/779,915

(22) PCT Filed: Jan. 23, 2014
(86) PCT No.: PCT/IB2014/058482

§ 371 Date: Sep. 24, 2015

(30) Foreign Application Priority Data
Mar. 24, 2013 (GB) 1305349.1

(51) Int. Cl. B64C 27/54; B64D 47/08; B64C 27/06

(52) U.S. Cl. CPC B64C 27/54; B64C 27/06; B64D 47/08

(57) ABSTRACT

A rotorcraft rotor head has: (i) two or more rotor blades attached to rotate about a rotor axis, and pivot through a flapping and/or teetering hinge, and having a pitch angle; (ii) pitch angle changing means for collectively changing said pitch angle; (iii) centrifugal pitch stop mechanism having an activation point and comprising one or more centrifugal plates; and (iv) control means for providing a control input to said pitch angle changing means; wherein said centrifugal pitch stop mechanism is configured to attain an activated state and to interact with said pitch angle changing means; wherein said activated state is attained when the rotational speed of said rotor blades is greater than said activation point and when a control input is provided by said control means; and wherein said activation point is less than the minimum rotational speed of the rotor blades that is required for flying the rotorcraft.

This application claims the benefit of the provisional specification GB1305349.1 filed on 24 Mar. 2013, which is incorporated in its entirety herein by reference.

### FIELD OF THE INVENTION

The present invention relates to a novel rotor head mechanism for a rotorcraft, and particularly for an autogyro. The rotor head incorporates a collective pitch mechanism that enables the pilot to adjust the pitch of rotor blades prior to and during take-off. After take-off, the rotor head mechanism automatically sets the pitch of the blades to a predetermined pitch angle which is suitable for providing sustained flight of the rotorcraft. An autogyro fitted with the rotor head mechanism of the invention, thus retains much of the simplicity and flight characteristics of a conventional fixed pitch autogyro rotor system, yet it has the added capacity for short and/or vertical take-off when fitted with a sufficiently powerful pre-rotator mechanism.

### BACKGROUND OF THE INVENTION

### 1. Development and Flight Characteristics of Autogyros

Ever since their invention in the early 1920s by the Spanish engineer Juan de la Cierva, autogyros have continued to develop. This development, has however been relatively slow especially since autogyro type aircraft almost became extinct after the advent of helicopters in the 1940's. Helicopters, with their well-known hovering and vertical take-off/landing capabilities are generally seen to be more versatile than autogyros, and autogyros also have limited capacity to hover. In spite of these draw-backs, much attention has still been paid to autogyro type aircraft as they combine many of the advantages of helicopters with those of fixed-wing aircraft. They also have some capabilities which are unsurpassed by any other form of aviation.

Although visually similar to a helicopter an autogyro is actually much more akin to a fixed-wing aircraft in terms of its flight characteristics and relatively simple controls. Unlike a fixed-wing aircraft however, an autogyro does not stall; even at relatively low forward flying speed the tips of the rotor blades continue to fly through the air at several hundred miles an hour. This gives autogyros an added margin of safety, as even in the event of complete engine failure, autorotation allows the pilot to maintain complete control of the aircraft and is able to safely return the aircraft to land. Moreover, since the tips of the rotor blades of an autogyro continuously rotate at several hundred miles an hour, this results in certain degree of gyroscopic stability, which when combined with the fact that lift is generated by the air flowing rapidly over the surface of the rotor blades (Bernoulli's principle) means that autogyros are less susceptible to extreme wind conditions.

In contrast to helicopters, autogyros are mechanically simpler, generally easy to operate and are far less expensive to purchase and maintain. In many flight operations, and where precise hovering capacity is not essential, autogyros may still be preferred to helicopters and fixed-wing aircraft (aerial photograph, police surveillance, search and rescue operations etc.). When comparing the differing capabilities of autogyros and helicopters, it is critically important to understand the difference in the way the rotor blades of an autogyro perform relative to a helicopter. In a typical helicopter, in order to remain airborne, the mass of the aircraft is in balance with the amount of air that is drawn through the rotor blades from above the aircraft, and is essentially similar to the behaviour of a household fan. In an autogyro however, lift is generated solely by having a rotor system that flies through the air creating lift by way of the Bernoulli effect (efficient autogyro rotor blades typically resemble cambered airfoils in cross-section, whereas helicopter blades are often symmetrical in cross-section). The air flowing over both sides of the autogyro rotor blades is therefore less turbulent and the air generally flows from below the aircraft out through the top of the rotor system. In view of this, a helicopter requires much greater energy to hover, and they can typically only hover for short periods of time in order to minimise fuel consumption and to prevent the engine from overheating. In contrast, modern autogyros which incorporate an efficient rotor system and lightweight materials, can easily hover for extended periods of time, simply by utilising the energy exerted by the force of a moderate wind. This requires only minimal effort by the pilot to maintain the aircraft in a stationary position, and depending upon the force of the wind, the engine generally operates only just above its idling position, thus minimising fuel consumption. Many autogyros are so intrinsically stable under such hovering conditions that they can be operated safely, even without the need for the pilot to keep hold of the flight controls. Moreover unlike conventional helicopters, autogyros do not suffer from the effects of downwash turbulence. Small autogyros are also relatively fuel efficient; an autogyro in South Africa recently set a record for a non-stop flight of 1572 km which was accomplished using no more than 260 litres of fuel. This therefore compares very favourably with a similarly sized Hughes/Schweizer 300C helicopter which consumes in the region of 50 litres p/h at cruise speed.

### 2. Development of Mechanisms to Facilitate “Jump” Take-Off

Over the years, a considerable amount of success has been achieved in giving more vertical takeoff capabilities to autogyros. One of the main concepts to give autogyros a vertical takeoff capability is the “jump” take-off development; wherein an autogyro fitted with a collective pitch mechanism has the lift rotor pre-rotated mechanically beyond its normal rotational speed. Subsequently, the prerotator drive mechanism is disconnected whilst the collective pitch of the rotor blades is increased simultaneously. This produces a sudden helicopter-like downward flow of air through the rotor which, given sufficient inertia of the rotor blades produces enough vertical lift to “jump” the aircraft into the air. As the speed and lift of the rotor decays, enough forward speed is gained through the use of a propeller. Flight can then be continued with the rotor blades operating at a reduced “autorotative” pitch.

One of the earliest examples of an autogyro fitted with means for adjusting the pitch of the blades is disclosed in U.S. Pat. No. 1,947,901 by Juan de la Cierva (1934), the contents of which are incorporated herein by reference. U.S. Pat. No. 1,947,901 demonstrates that by adjusting the individual pitch of the blades, one is able to vary the lifting efficiency of the rotor system as a whole. This enables an aircraft fitted with such a system to be able to achieve greater rates of climb, as well as having a shorter take-off distance. Amongst other things, U.S. Pat. No. 1,947,901 discusses that such an aircraft should be able to increase the pitch of the individual rotor blades to 2 to 4° above a substantially minimised drag collective pitch angle.

Juan de la Cierva also patented several jump take-off mechanisms in GB484376 and GB492816. In GB484376 the rotor head is designed with a unique attachment of the rotor blades to the hub, such that said attachment means comprises a screw-threaded joints coaxial with the blades. The action of centrifugal force upon the rotors blades in conjunction with a controllable means enables the rotor blades to be drawn outwards, with a corresponding increase in pitch of the rotors, mediated by the screw-threaded joints.

In GB492816 a fully automatic jump take-off mechanism is disclosed, and which incorporates a number of uniquely positioned hinges. When the rotor blades are prerotated through the use of the drive mechanism, the lagging of the rotor blades results in a reduction in the blade pitch. Upon release of the drive mechanism, blade lag disappears resulting in an increment in pitch angle, thus achieving jump take-off. The unique arrangement of the pivots/hinges also makes use of centrifugal force which effectively locks the rotor blades in their flight pitch angle, whilst still allowing other aerodynamic forces to be accommodated through the use of the other hinges.

More recently, and following the advent and general adoption of the two-bladed teetering type rotor heads on autogyros, U.S. Pat. No. 4,092,084 (the contents of which are incorporated herein by reference) discloses a two-bladed semi-rigid teetering rotor head for an autogyro which incorporates a fully automated collective pitch mechanism. This relatively simple mechanism incorporates two mechanical stops which allow the rotor blades to be efficiently brought up to a high rotational speed by maintaining an initial low pitch angle of the rotor blades. By tilting the angle of the rotor as a whole, the pitch of the two rotor blades could then be collectively increased to a second stop position. Such a mechanism allowed the aircraft to substantially reduce its take-off distance when compared to a conventional fixed pitch teetering rotor head. In spite of its simplicity, the rotor head as disclosed in U.S. Pat. No. 4,092,084 has a number of disadvantages; the mechanism itself is essentially fully automatic and it offers the pilot no direct control for adjusting the pitch of the rotor blades. Moreover, with only two stop positions and the inability to attain a high collective pitch angle, the design does not facilitate the possibility of achieving true vertical ‘jump’ take off. Moreover, without any control means provided to the pilot, such a system cannot controllably and safely be returned to its low pitch position. Questions must also be asked over the safety and performance of such a rotor head during low g manoeuvres.

Another type of jump take-off autogyro is what has become known as the “Gyrhino”. Only two of these autogyros appear to have been built by the enthusiast Richard DeGraw. The design incorporates a three bladed feathered collective pitch rotor system, and seems to incorporate many helicopter parts in its construction. However, whilst these two aircraft have shown to implement the jump take-off concept extremely successfully (there are many YouTube videos which are a testament to DeGraw's efforts), the aircraft itself is unlikely to enter mainstream production, and it is also known that one of these two aircraft was the subject of a serious accident in 2011.

A collective pitch mechanism is also known to have been implemented on at least one of the Air Command autogyros. This design was based around a conventional two bladed teetering rotor head. The rotor blades could be feathered to achieve take-off, and would subsequently operate only in a fixed pitch configuration. The rotor head itself comprises a feathering hinge for each rotor blade, to which pitch horns are attached. Initially the blades are prerotated to up to about 375 rpm (around 1.5 times their typical flight rpm) utilising a powerful hydraulic prerotator mechanism. The collective pitch of the blades can then be increased to their predetermined fixed flight pitch (i.e. the optimal flight characteristic pitch) by activating a safety pin mechanism. Upon activating the aforementioned safety pin mechanism, the spring loaded pitch mechanism then immediately flips the collective pitch of the rotor blades up to their flight pitch angle which is then locked in place when the safety pin mechanism is released. This system whilst being both simple and effective still nonetheless suffers from several disadvantages; firstly the ability of the aircraft to perform a jump take-off is somewhat limited as there is no way of increasing the collective pitch of the rotor blades above their intended fixed flight pitch angle. Secondly, in order to reactivate the mechanism and to depitch the blades ready for another takeoff, a handle at the rotor head itself needs to be pulled whilst simultaneously activating the safety pin mechanism in the cockpit; in short, there is no way of automatically/mechanically reducing the pitch of the blades in preparation for another take-off.

Another jump take-off autogyro is the Heliplane 18A-280. This rotorcraft comprises a three bladed feathered rotor head which appears to share many similarities with a helicopter rotor head. The profile of the rotor blades appears to be symmetrical which suggests that the pitch of the rotors is intended to be fully adjustable during flight, and is therefore not optimised for a single fixed pitch flight angle. Therefore in spite of the numerous advantages that this aircraft has to offer, especially when compared to the running costs of a similarly sized helicopter; the rotor system of this aircraft appears to be overly complex, and a more efficient, cost-effective and easier to operate design would therefore be desirable for modern autogyros.

In U.S. Pat. No. 4,726,736 the contents of which are incorporated herein by reference, a two-bladed collective pitch rotor head mechanism for an autogyro is disclosed. By manually adjusting a lever on the rotor head, the pilot is able to collectively adjust the pitch of the rotor blades. An autogyro fitted with such a system is said to be capable of jump take-off, as well giving the pilot the ability to change the pitch during flight/landing. The mechanism of U.S. Pat. No. 4,726,736 however does not incorporate any means to accurately or consistently set the pitch of the rotor blades to a predetermined pitch angle for flying. Additionally, the mechanism is unconventional in its attachment of the rotor blades to the hub which does not appear to teeter. The mechanism is also somewhat inconvenient as it necessitates the pilot to release one or more of his hands from the thrust/control column during take-off so as to operate the mechanism.

According to U.S. Pat. No. 4,741,672, the contents of which are incorporated herein by reference, a two-bladed pitch adjustable teetering rotor head mechanism for jump take-off is disclosed. As well as discussing the importance and significance of developing a collective pitch system for a teetering rotor head, U.S. Pat. No. 4,741,672 goes on to propose the first such solution to solving this particular problem. A control lever positioned within easy reach of the pilot enables the pilot to activate the system. Provided that the rotor system has been prerotated to a sufficiently high enough speed, a jump take-off can be performed, and the rotor system subsequently behaves as a conventional fixed pitch teetering rotor mechanism. One of the main drawbacks of the system proposed in U.S. Pat. No. 4,741,672 however, is that after landing, the pilot must first wait for the rotor blades to come to a complete standstill before being able to reset the rotor mechanism located at the top of the mast. Additionally, the mechanism only allows for two positions: a ‘pitched’ position intended for flight, and a ‘depitched’ position intended for prerotation. In a similar way to the Air Command autogyros as mentioned previously; there is no possibility to provide for a collective pitch angle which is optimised for jump take-off, as it can only provide a ‘pitched’ position intended for flight. Again, this limits the performance of this mechanism.

U.S. Pat. No. 5,301,900 and related U.S. Pat. No. 5,544,844 (Groen Brothers Aviation) the contents of which are incorporated herein by reference, relate to autogyros which are fitted with a fully controllable collective pitch two-bladed teetering rotor head mechanism. The mechanism is operated through a lever fitted in the cockpit which is coupled to the mechanism in the rotor head by a cable means. The disclosed mechanism not only enables the collective pitch to be adjusted at jump take-off, but it also enables the collective pitch angle of the rotor blades to be fully controllable during flight and landing. One of the beneficial features of having such a rotor head mechanism is that it enables the collective pitch angle to be reduced to minimise drag at high airspeeds. This in turn reduces the speed of rotation of the rotor blades, allowing the aircraft to attain greater air speeds than would otherwise be achievable. Whilst such a mechanism has many advantages, it is also overly complex, and utilises many separate moving components. Having a mechanism which directly affects the flight performance characteristics of the aircraft also requires careful consideration and will requires additional specialist training. The use of such a complex and sophisticated mechanism is also likely to be subjected to strict aviation regulations, and which go beyond those which have already been imposed upon many types of autogyros in recent years (and in jurisdictions such as the United Kingdom for instance). Furthermore, whilst the rotor head mechanism of U.S. Pat. No. 5,301,900 and U.S. Pat. No. 5,544,844 is based upon a semi-rigid teetering rotor head type configuration, the rotor head seems to lack any means to isolate the desired collective pitch of the rotor blades from the see-saw motion of the teetering axis; this will inevitable result in a certain amount of undesirable cyclic pitch motion during flight (resulting in undue wear on the components and inducing additional vibrations on the aircraft).

Further to the disclosures of U.S. Pat. No. 5,301,900 and U.S. Pat. No. 5,544,844, U.S. Pat. No. 5,304,036 (Groen Brothers Aviation) relates to an alternative semi-rigid teetering rotor head that features a collective pitch mechanism (the contents of U.S. Pat. No. 5,304,036 are also incorporated herein by reference). One of the improved features of this mechanism is the pair of teeter compensator bearings which link the collective pitch control mechanism to the pitch horns attached to the rotor blades. With such a rotor head, as the pitch control means is used, the teeter compensator bearings move along the extended teeter bolts, and the pitch links therefore always remain on the teetering axis. Such a mechanism therefore prevents any cyclic pitch oscillation as the blades revolve and teeter. In spite of these advantages, the rotor head of U.S. Pat. No. 5,304,036 still incorporates many separate components, and is still considered to be overly complex and likely to require specialist training and regulatory requirements in order to operate.

A simpler alternative mechanism for a two bladed teetering rotor is proposed in RU2313473 and EP2279943 (which are incorporated herein by reference). This mechanism enables the pilot to vary the collective pitch of the rotor blades and gives the aircraft vertical take-off capability. This simplicity is achieved through the use of a flexible torsion sleeve/torsion plate. However, unlike the rotor mechanism of U.S. Pat. No. 5,304,036 there does not appear to be any means to isolate the desired collective pitch motion from an undesirable cyclic pitch motion caused by the teetering motion induced in forward flight. There also appears to be no provision in the mechanism to provide optimum pitch angles of the rotor blades during pre-rotation, take-off and/or flight.

In U.S. Pat. No. 5,853,145, the contents of which are incorporated herein by reference, a two bladed teetering rotor head mechanism is proposed which aims to minimise vibrational feedback characteristics transmitted to the body of the aircraft. The mechanism also incorporates a continuously collective pitch mechanism capable of vertical take-off and vertical landings. Whilst many of the improvements featured in U.S. Pat. No. 5,853,145 are generally applicable and important to the future development of autogyros, nonetheless the collective pitch mechanism itself still incorporates many of the drawbacks of earlier designs, particularly in terms of the number of moving parts and its operational complexity.

With reference to U.S. Pat. No. 7,448,571 and U.S. Pat. No. 7,677,492 (the contents of which are incorporated herein by reference) it is highly apparent that using mechanisms that collectively adjust the pitch of the rotor blades of an autogyro in flight substantially increase the burden on the pilot. Partly because unlike a helicopters rotor system, an autogyros rotor system is unpowered in flight, and also because unlike a helicopter rotor system which operates a constant rpm, the autogyro rotor rpm is continuously changing as the aircraft manoeuvres. If the collective pitch of the autogyros rotor blades is too high, the rotational speed of the rotor blades can drop exceptionally fast, and this can be impossible to correct as no power can be diverted to the rotor system. Conversely if the aircraft is flying at high air speeds; if the collective pitch is reduced too much, again a loss of control of the aircraft could easily result with potentially tragic consequences. In particular, U.S. Pat. No. 7,448,571 discusses the complexity and skill which is required to operate such a collective pitch mechanism on an autogyro. Means for measuring and calculating the optimum pitch of the rotor blades based upon a value Mu—the ratio of aircraft forward speed to the rotor tip speed is also discussed. In order to reduce this burden on the pilot, U.S. Pat. No. 7,448,571 is aimed at developing a computationally controlled means that enables for the degree of flapping and rotor RPM to be controlled automatically. In contrast to U.S. Pat. No. 7,448,571, U.S. Pat. No. 7,677,492 presents an alternative strategy, which relies on mechanical means for controlling the rotor's collective pitch angle relative to the rotational speed of the rotor. This is achieved in part by incorporating weights which move inside the rotor blades in response to the centrifugal force applied upon them. Such a rotor system however has many moving parts and it cannot be used with the wide range and choice of conventional rotor blades that are currently provided by many manufactures in many countries.

In view of the above, whilst collective pitch mechanisms proposed in the prior art offer a number of improvements over their predecessors, they still nonetheless introduce additional complexities and have associated costs. They are therefore considered to be too complex to be incorporated into the majority of light-weight autogyros which continue to dominate todays market. Indeed, at the present time, even with the development of new autogyro aircraft, and a better understanding of their flight characteristics; the vast majority of autogyros in operation and/or production remain of the conventional fixed pitch configuration which have no collective pitch mechanism and no vertical take-off capability. It is therefore an object of the present invention to go some way to overcoming the above-noted deficiencies in this art; and/or to at least provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In one aspect, the present invention relates to a rotorcraft rotor head comprising: (i) two or more rotor blades and/or rotor blade attachment means, wherein said rotor blades and/or said rotor blade attachment means are rotatably attached to rotate about a rotor axis, and pivot through a flapping and/or teetering hinge, and have a pitch angle; (ii) pitch angle changing means for collectively changing said pitch angle; (iii) centrifugal pitch stop mechanism having an activation point and comprising one or more centrifugal plates; and (iv) control means for providing a control input to said pitch angle changing means; wherein said centrifugal pitch stop mechanism is configured to attain an activated state and to interact with said pitch angle changing means; wherein said activated state is attained when the rotational speed of said rotor blades and/or said rotor blade attachment means is greater than said activation point and when a control input is provided by said control means; and wherein said activation point is less than the minimum rotational speed of the rotor blades that is required for flying the rotorcraft.

In another aspect of the present invention the activated state of said centrifugal pitch stop mechanism is configured to interact with said pitch angle changing means to facilitate and collectively maintain said pitch angle at a predetermined pitch angle B which is suitable for sustained flight of the rotorcraft, and wherein said predetermined pitch angle B which is suitable for sustained flight of the rotorcraft is preferably an optimal flight characteristic pitch angle.

In another aspect of the present invention the pitch angle of all of the individual rotor blades can be set equally and collectively to said predetermined pitch angle B which is suitable for sustained flight; wherein said pitch angle B can be sustained throughout a 360 degree rotation about said rotor axis; and wherein said pitch angle B can be sustained independently of any motion which can be facilitated through said flapping and/or teetering hinge.

In another aspect of the present invention, irrespective of the rotational speed of said rotor blades and/or said rotor blade attachment means, said control means and said pitch angle changing means enable the pitch angle of said rotor blades and/or said rotor blade attachment means to be held at a collective pitch angle C, wherein said collective pitch angle C is greater than said predetermined pitch angle B, and preferably wherein said collective pitch angle C is optimised for take-off performance of the rotorcraft.

In another aspect of the present invention the collective pitch angle C is anywhere between 2 and 15 degrees, more preferably between 2 and 9 degrees, including the specific collective pitch angles of 2, 2.5, 2.75, 3, 3.25, 3.5, 4, 5, 6, 7 or 8 degrees; and wherein said predetermined pitch angle B which is suitable for sustained flight of the rotorcraft is anywhere between 1.5 and 7 degrees, including collective pitch angles of 1.5, 2, 2.5, 3, 3.5, 4, 4.5, 5, 5.5, 6 or 6.5 degrees, and which is preferably at 2 degrees ±0.5°.

In another aspect of the present invention the control means and said pitch angle changing means enable the pitch angle of said rotor blades and/or said rotor blade attachment means to be set to a minimised drag collective pitch angle A which produces minimal drag upon rotation of the rotor blades.

In another aspect of the present invention the rotor head is a semi-rigid rotor head which comprises two of said rotor blades and/or said rotor blade attachment means, and which pivot through a teetering hinge.

In another aspect of the present invention the teetering hinge has an axis of rotation, and wherein said axis of rotation is either substantially perpendicular to the longitudinal axis of said rotor blades, preferably within)±1°; or else said axis of rotation is not perpendicular to the longitudinal axis of said rotor blades and is offset from the longitudinal axis of said rotor blades by between 50 and 89 degrees, and which is preferably offset by either 60 or 75 degrees.

In another aspect of the present invention the pitch angle changing means comprises a feathering hinge, and wherein said feathering hinge may optionally further comprise one or more feathering hinge bearings and/or a torsion plate.

In another aspect of the present invention the centrifugal plates are in the form of a weighted lever and which comprises one or more weights located towards the distal end of each centrifugal plate, and wherein said centrifugal pitch stop mechanism may be configured to provide a deactivation point which is at 300 rpm or less.

In another aspect of the present invention the activation point is configured to be between 100 rpm and 350 rpm, more preferably between 150 rpm and 320 rpm, yet more preferably between 200 rpm and 300 rpm, and which is especially preferred to be in the range of between 250 rpm and 290 rpm.

In another aspect of the present invention the rotor head and/or pitch angle changing means further comprises one or more pushrods which direct a control input from said control means to said pitch angle changing means; and wherein said control input is directed to said one or more pushrods preferably via either a cable mechanism, a lever mechanism, a hydraulic system, a pneumatic system, or a combination thereof.

In another aspect of the present invention the rotor head further comprises a connective means for a prerotator mechanism.

In another aspect of the present invention the prerotator mechanism is capable of accelerating the rotational speed of said rotor blades and/or said rotor blade attachment means to a speed in excess of 100 rpm, preferably between 200 rpm and 800 rpm, more preferably between 300 rpm and 600 rpm, yet more preferably between 350 rpm to 550 rpm, or which is especially preferred to be in the range of from 400 rpm to 525 rpm.

In another aspect of the present invention the control means comprises an operative handle, an electrical activation switch or an electrical push activation switch.

In another aspect of the present invention the rotor head further comprises an electrical warning light such as a light emitting diode (LED), that provides information regarding the activated state of said centrifugal pitch stop mechanism.

In another aspect of the present invention the rotor head is in the form of a kit, and which may be accompanied by instructions that detail how the rotor head should be assembled and utilised; and wherein said kit may optionally include two or more rotor blades.

In another aspect of the present invention the kit, comprises components which are specifically adapted to allow the rotor head to be fitted to particular types and models of rotorcraft, including but not limited to those manufactured by Autogyro GmbH (including for instance the MTOsport, Cavalon and Calidus models), Magni Gyro (including the M14, M16, M18, M22, M24 models), Phenix Autogyro, Celier Aviation (especially the various models of the Xenon autogyro), Rotortec GmbH (including the various Cloud Dancer Models), Aero-Sport International (including the Kahu Autogyro models), ELA Aviacion (including the ELA 07, ELA 08 and ELA 09 models), Hummingbird Gyrocopter (including the various H1 models), Arrow Copter (particularly the AC20), Sport Copter International (including the Sport Copter models, Lightning and Vortex models), Groen Brothers Aviation etc. etc.

In another aspect of the present invention the rotor head is an autogyro rotor head.

In another aspect of the present invention relates to a rotorcraft or autogyro comprising at least one rotor head of the invention.

In another aspect of the present invention the rotorcraft or autogyro of the invention is for aerial photography; for specialist photography including the use of infra-red night vision and/or thermal imaging cameras; for filming, including for sports coverage, media or news applications; for advertising; for feature film productions; for police surveillance and/or law enforcement; for fire fighting; for event security monitoring; for scenic tours; for search and rescue operations, including for medical and/or patient transport; for agricultural applications, including crop spraying, animal herding or forest conservation; for land surveying, including for pipeline monitoring; electricity power cable management, and the maintenance and/or servicing thereof; or for industrial construction work.

Another aspect of the present invention provides an autogyro comprising an airframe, mast, rudder, one or more engines mounted onto said airframe for providing a propulsion power plant (preferably a forward propulsion power plant comprising a propeller), and rotor head being tiltably attached to said mast to tilt relative to the masts longitudinal axis and to thereby provide a head pitch axis and a head roll axis; said rotor head comprising: (i) two or more rotor blades, wherein said rotor blades are rotatably attached to rotate about a rotor axis, and pivot through a flapping and/or teetering hinge, and have a pitch angle; (ii) pitch angle changing means for collectively changing said pitch angle of said rotor blades; (iii) centrifugal pitch stop mechanism having an activation point and comprising one or more centrifugal plates; and (iv) control means for providing a control input to said pitch angle changing means; wherein said centrifugal pitch stop mechanism is configured to attain an activated state and to interact with said pitch angle changing means; wherein said activated state is attained when the rotational speed of said rotor blades is greater than said activation point and when a control input is provided by said control means; and wherein said activation point is less than the minimum rotational speed of said rotor blades that is required for flying the autogyro.

In another aspect of the present invention the rotorcraft comprises a prerotator mechanism, and wherein said prerotator mechanism preferably comprises: i) one or more gears which are connected to said engine through a power transmission means; or ii) one or more thrust means attached to said rotor blades, wherein said thrust means is facilitated through the use of a suitable rocket fuel, preferably through the decomposition of hydrogen peroxide.

In another aspect of the present invention the autogyro further comprises: a first sensory means which enables the rotational speed of said rotor blades to be determined; and a second sensory means which enables the collective pitch angle of said rotor blades to be determined; and wherein said first sensory means and said second sensory means can be used in conjunction to provide an information and/or warning system.

Another aspect of the present invention provides a method of performing a vertical takeoff and flight manoeuvre in a rotorcraft; said method comprising the steps of: 1) providing a control input to set the pitch angle of the rotor blades collectively to a minimised drag collective pitch angle A; 2) prerotating said rotor blades to a speed which is greater than the minimum rotational speed of the rotor blades that is required for flying the rotorcraft or autogyro; 3) providing a control input to increase the pitch angle of said rotor blades collectively to a pitch angle C so as to perform a vertical takeoff manoeuvre; and 4) removing said control input and thereby reducing the pitch angle of said rotor blades collectively to a pitch angle B which is suitable for flying the rotorcraft.

### AIMS OF THE PRESENT INVENTION

In view of the various disadvantages inherent to the prior art, especially when compared to the absolute simplicity and operational reliability of a conventional autogyro fitted with a fixed pitch semi-rigid teetering rotor system; it is therefore an aim of the present invention to provide a novel rotor head which incorporates a collective pitch mechanism that allows a rotorcraft fitted with such a rotor head to achieve jump take off capability, whilst retaining much of the simplicity and reliability offered by a fixed pitch teetering rotor head during flight.

To facilitate the jump take-off, it is a further aim of the present invention to provide a rotor head that enables the rotor blades to adopt a collective pitch angle which is higher than the collective pitch angle of the rotor blades when set to a pitch angle suitable for flight.

It is a further aim of the present invention that said rotor head enables the pitch of the rotor blades to be reduced collectively after take-off so that they automatically arrive at a predetermined pitch position (B) which is optimised for flight performance i.e. the “optimal flight characteristic pitch”.

It is a further aim of the present invention that said rotor head is at least partially automatic, and wherein after landing, the pitch of the rotor blades can easily be ‘reset’ to a substantially minimised drag collective pitch angle at the control of the pilot from the cockpit using a single control means, and without the need for bringing the rotor blades to a complete standstill.

It is a further aim of the present invention that said rotor head should only allow the pilot to ‘reset’ the pitch of the rotor blades to a substantially minimised drag collective pitch angle once the rotational speed of the rotor blades has fallen below a pre-determined speed/activation point, wherein said activation point should also be below the minimum rotational speed of the rotor blades that is required to achieve sufficient lift for flight.

It is a further aim of the present invention that said rotor head should be operable by a simple control means; and which comprises either a mechanical hand operated lever with both activated and non-activated positions, or more preferably by an electrical activation switch which similarly provides an activated (on) and non-activated (off) position/control input.

It is a further aim of the present invention that said rotor head can accommodate one or more sensory means as well as an informative means which can provide information to the pilot about the operational state of the rotor head, including the rotational speed of the rotor blades, and a means of determining the collective pitch angle of the rotor blades.

It is a further aim of the present invention that said rotor head and its control means can accommodate an electrical trim switch, which enables the pilot to adjust the maximum travel position of the collective pitch mechanism of the rotor head; thereby enabling a maximum pitch angle of the rotor blades to be adjusted/selected.

It is a further aim of the present invention to provide a rotor head which does not induce any cyclic pitch oscillation as the rotor blades revolve and teeter. I.e. the rotor head is configured such that when the pitch angle of the rotor blades is set to the predetermined pitch angle which is suitable for sustained flight: i) the pitch angle of all of the individual rotor blades can be set equally and collectively to said predetermined pitch angle; ii) said pitch angle can be sustained throughout a 360 degree rotation about said rotor axis; and iii) said pitch angle which is suitable for sustained flight can be sustained independently of any motion which can be facilitated through said flapping and/or teetering hinge.

It is a further aim of the present invention that said rotor head also accommodates a directional control means that enables the rotor head to tilt controllably relative to the masts longitudinal axis and to thereby provide a head pitch axis and a head roll axis.

It is a further aim of the present invention that said rotor head is extremely simple and safe to operate, and does not fundamentally alter the flight characteristics of the aircraft and which can therefore be integrated with existing fixed pitch autogyro pilot training programs.

It is a further aim of the present invention that said rotor head could be manufactured and made available in kit form, and which could be manufactured so as to be retrofitted to a number of the aircraft currently in operation.

It is a further aim of the present invention to provide a rotorcraft which has been fitted with said rotor head.

It is a further aim of the present invention to provide a method of performing a jump take-off manoeuvre in an autogyro fitted with said rotor head.

Part of the inspiration for the mechanism of present invention and its inventive concept comes from the unlikely source of a Parker ball point pen. Such a pen has essentially three main states of existence (A), (B) and (C). When the pen is not in use, the pen tip is protected and cannot be used for writing as it is retracted inside the pens exterior; this state (A) is analogous to the collective pitch mechanism of the present invention where the pitch of the rotor blades is held at their minimised drag collective pitch angle, and wherein flight of the aircraft is impossible. In order to write with such a ball point pen, the pen tip must be promoted by pressing and holding the activation button, this puts the pen tip in an extended position (C), which is unsuitable for sustained writing, but which is required in order to get the pen tip to state (B). State (C) is analogous to the mechanism of the present invention, where the collective pitch of the rotor blades is increased to a maximum pitch angle which is ideal for take-off, but unsuitable for sustained flight. Finally upon release of the pens activation button, the pen tip is retracted slightly to a point (B) which has been optimised for sustained writing; this is analogous to the mechanism of the present invention, wherein the collective pitch of the rotor blades is automatically reduced to, and is locked at a fixed pitch position (B) which is ideally suited for sustained flight consistent with a fixed pitch autogyro.

In accordance with the present invention, the key component that makes all of this possible is the novel centrifugal pitch stop concept. By the incorporation of a centrifugal pitch stop, it is not only possible to automatically fix the collective pitch of the rotor blades at their optimal flight characteristic pitch (B), but it also provides an intrinsic safety feature which makes it impossible to accidentally reduce the pitch of the rotor blades to the minimised drag collective pitch angle when the aircraft is in flight. Furthermore, and analogously to the Parker pen; the whole collective pitch mechanism can be configured to be controlled through a simple push button activation switch.

### DESCRIPTION OF THE FIGURES

FIG. 1 shows a prior art example of a modern pusher type autogyro which has a fixed pitch semi-rigid rotor system.

FIG. 2 shows a prior art example of a modern tractor type autogyro which also has a fixed pitch semi-rigid rotor system.

FIG. 3 exemplifies a conventional fixed pitch semi-rigid rotor system showing its simplicity and key components, as well as detailing the rotor axis of rotation, and helping to explain the concept of blade flapping.

FIG. 4 details the concept of the collective pitch angle q, the control of which lies at the heart of the present invention.

FIG. 5 shows the cross sectional shape of a typical autogyro rotor blade.

FIG. 6 shows the mast and directional control means typically used on autogyros of the prior art which utilise rotor blades which are fixed in pitch.

FIGS. 7, 8 and 9 show schematic representations which aids in explaining the concept behind the collective pitch mechanism of the present invention. It also aids in understanding the importance and purpose of the centrifugal pitch stop and its effect upon the position of the collective pitch bar.

FIGS. 10 and 11 show a prototype/model which was prepared in accordance with the present invention. This prototype was developed to explore the concept of utilising a centrifugal pitch stop as part of an autogyro jump take-off mechanism. FIG. 10 shows parts of the rotor head with the centrifugal pitch stop in its deactivated state, whilst FIG. 11 shows the centrifugal pitch stop in its activated state.

FIG. 12 shows an example of a mechanism prepared in accordance with the present invention viewed as a cross-section through the rotor hub. Representations 1-3 show the mechanism in its three main operational states.

FIG. 13 exemplifies the components of a centrifugal pitch stop which can be utilised in accordance with the present invention.

FIG. 14 shows a side-on view of a rotor mechanism prepared in accordance with the present invention, and which substantiates one means for providing a feathering hinge. It also highlights the alignment of the pitch horns and its associated bearings with the teeter axis.

FIG. 15 shows a top down view of similar rotor mechanism to that as shown in FIG. 14.

FIG. 16 shows a top down view of another rotor mechanism prepared in accordance with the present invention, wherein the axis of rotation through the teetering hinge is not perpendicular to the rotor span/longitudinal axis of the rotor blades, and is instead offset from the rotor span by 60 degrees.

FIG. 17 shows a top down view of a three bladed rotor design which can also be utilised in accordance with the present invention.

FIG. 18 shows another example of a mechanism prepared in accordance with the present invention. Here you can see the mechanism in its deactivated position with the rotor links/rotor blade attachment means approximately parallel with each other.

FIG. 19 shows another representation of the mechanism shown in FIG. 18. Here the mechanism is drawn in its activated state. This highlights the interlocking of the centrifugal plates with the pitch stop, and the corresponding change in the angle of the rotor links/rotor blade attachment means.

FIG. 20 shows three representations of a side on view of a rotor head prepared in accordance with the present invention, and which substantiate one method by which a pitch control cable can be configured and utilised in conjunction with a pitch control sensor/microswitch.

FIG. 21 shows a bottom up view of a similar rotor head to that shown in FIG. 20.

FIG. 22 shows the parts of a simple control lever which can be utilised to operate the collective pitch mechanism of the present invention.

### DETAILED DESCRIPTION OF THE INVENTION

In the description in this specification reference may be made to subject matter which is not within the scope of the claims of the current application. That subject matter should be readily identifiable by a person skilled in the art and may assist in putting into practice the invention as defined in the claims of this application.

Throughout the description and claims, the terms “comprise”, “comprises”, “comprising”, “comprised” and the like, are to be construed in an inclusive sense as opposed to an exclusive or exhaustive sense, that is to say in the sense of “consisting at least in part of”. When interpreting each statement in this specification that includes the term “comprises”, features other than that or those prefaced by the term may also be present. Related terms such as “comprise”, “comprising” and “comprised” are to be interpreted in the same manner.

The term “autogyro” as used herein contemplates any flying vehicle which possesses one or more unpowered rotor systems which constitute the main source of lift during flight and which utilise the principal of autorotation; wherein said vehicle further comprises a means for providing a substantially horizontal force to said vehicle. The term autogyro therefore encompasses aircraft which in addition to possessing a rotor system, are powered by: one or more propellers located towards the front half of the aircraft (tractor type configuration); powered by one or more propellers towards the rear half of the aircraft (pusher type configuration); as well as gyro gliders when being towed behind another vehicle such as a land based motor vehicle or motor boat. The term autogyro is also intended to encompass an aircraft of any size, including for example those capable of carrying one or more human occupants, as well as smaller ‘model’ aircraft including those operated by remote/radio control. The term autogyro as defined above can also be used interchangeably with the terms “gyrocopter”, “rotaplane” and “gyroplane” which for the purposes of this specification have the same exact meaning.

The term “rotorcraft” as used herein refers to any aircraft which comprises one or more rotor systems which constitute the main source of lift during flight. Such a rotor system can be either entirely or partially powered in flight, or else entirely unpowered in flight. The term rotorcraft therefore encompasses both traditional helicopter rotorcraft as well as autogyro rotorcraft, and it also includes hybrid type/partially powered rotorcraft as described in U.S. Pat. No. 4,653,705.

The term “autorotation” as used herein refers to the principal by which the rotor blades of a rotorcraft are maintained in a state of constant rotation which is achieved by maintaining a constant airflow over the surface of the rotor blades, the rotor blades acting as a rotating wing generating lift by Bernoulli's principle. The airflow over the rotor blades typically being generated by forward motion of the rotorcraft.

The term “minimised drag collective pitch angle” as used herein refers to a pitch angle q which represents the collective pitch of the rotor blades being set to an angle of attack/pitch angle which experiences a state of minimal drag, and which may also simultaneously produce minimal lift. The pitch angle q depends heavily upon the profile of the rotor blades. For rotor blades which are exactly symmetrical in cross section, the minimised drag collective pitch angle q would be zero. However since autogyro rotor blades are not usually symmetrical in profile, q is usually slightly less than zero. Therefore depending upon the profile of rotor blades that are to be utilised, the minimised drag collective pitch angle q may range from −2° to 1°, more preferably between −1° and 0.5° and more preferably between about −0.5° to 0.2°.

The term “fixed pitch” as used herein refers to a rotor system in which the pitch angle q/angle of attack of the rotor blades relative to the rotor hub is fixed in place. For sustainable flight, typically the pitch angle/angle of attack of the rotor blades is fixed to between 0 and 10 degrees, and more usually between about 1.5 and 5 degrees, and more preferably at an angle of from about 1.5 to 4 degrees, with around 2 degrees being particularly preferred for a NACA 8-H-12 aerofoil. A conventional autogyro which is flying in a fixed pitch configuration, has no ability to adjust or control the amount of lift generated by the rotor blades other than by adjusting the head pitch axis of the rotor head as a whole. Whilst a rotorcraft fitted with the rotor head of the present invention has some ability to alter the collective pitch of the rotor blades; during sustained flight, it is intended only to operate in a “fixed pitch” configuration utilising an angle of attack which lies within the range as noted above.

The term “semi-rigid rotor” is defined as being a two bladed rotor system which does not have a lead-lag hinge in the way a fully articulated rotor system does. The semi-rigid rotor system can be said to be rigid in-plane, because the blades are not free to lead and lag, but they are not rigid in the flapping plane through the incorporation of a teeter hinge. Semi-rigid rotor systems may comprise a coning hinge in addition to the teeter hinge (in accordance with a rotor head of a Robinson R22 helicopter for example); alternatively a coning hinge may be absent (in accordance with a Bell 206 helicopter for example) as the rotor head can be designed to incorporate a certain coning angle of the rotor blades. In addition to setting a predetermined coning angle, the absence of coning hinges can also be facilitated by the use of flexible rotor blades which allows a certain amount of coning to occur through blade bending. In accordance with the present invention, the presence of coning hinges is entirely optional. Most conventional autogyros do not normally include coning hinges, and for the sake of simplicity, it is usually preferred to incorporate a predetermined coning angle, rather than adding further complexity to the aircraft.

The term “flapping” as used herein, and as generally known in the art relates to the phenomenon whereby the blades of a rotor system are allowed to flap through a flapping hinge. An ability to flap is a critical requirement of a rotor system of a rotorcraft due to the inequality of lift that results between the advancing and retracting blades in forward flight. As the advancing blade experiences increased lift, the flapping hinge allows the advancing blade to flap up. As the rotor blade continues to rotate about its rotor axis and approaches the other side of the aircraft, it experiences somewhat reduced lift, and the rotor blade is then allowed to flap down through its flapping hinge.

The terms “teeter”, “teetering” and the like as used herein relate to flapping action that is mediated through a special kind of flapping hinge called a teetering hinge that has a teeter axis. The teetering hinge has been developed especially for rotor heads that only include two rotor blades, and particularly for semi-rigid rotor systems. An ability to flap is a critical requirement of a rotor system of an rotorcraft due to the inequality of lift that results between the advancing and retracting blades in forward flight. With a teetering rotor system; as the advancing blade experiences increased lift relative to the retracting blade, the teetering hinge allows the advancing blade to flap up whilst simultaneously forcing the retracting blade to flap down. The entire mechanical arrangement works like a child's see-saw.

The terms “feather”, “feathering” and the like as used herein relate to a means for adjusting the pitch angle q of the individual rotor blades, and which may for instance involve the use of a feathering hinge. A feathering hinge can be mediated through the use of suitable bearings (see for instance those used on conventional helicopters, including ultralight helicopters such as the Mosquito XE Ultralight Helicopter). Alternatively the feathering hinge may be in the form of a torsion plate which twists about a feathering axis. An increase in collective pitch can be mediated through all of the feathering hinges simultaneously, allowing the angle of attack of all of the rotor blades to be increased to produce more lift and drag. Many mechanisms and solutions for the feathering of rotor blades are known in the art, and can be suitably adapted for the purposes of performing the present invention. In addition to the use of a feathering hinge, and in order to control the degree of feathering, it is often preferable to use pitch horns which link the rotor blades to the control means through the feathering hinge.

The phrase “collective pitch” as used herein refers to the angle of attack/pitch angle of all of the rotor blades attached to the rotor head. A pitch angle changing means therefore enables the angle of attack/pitch angle q of all the rotor blades to be adjusted simultaneously/collectively, and which can be mediated through the use of feathering hinges.

The phrase “pitch angle changing means” as used herein refers to any means which enables the pitch angle of all of the rotor blades attached to the rotor head to be changed simultaneously and collectively. Typically the pitch angle changing means comprises at least one feathering hinge for each rotor blade. In a preferred embodiment, the pitch angle changing means further comprises a pitch horn, a pitch bar and one or more pushrods. Each pitch horn being connected to said pitch bar and pushrod through the feathering hinge, and wherein the relative position of the pitch bar is mediated by a control input which is applied to the pushrod.

The term “optimal flight characteristic pitch” as used herein is the optimised/most efficient pitch angle (q) that is determined for a given set of rotor blades of known aerofoil profile in terms of both lift and drag when intended to operate on a fixed pitch autogyro. In a preferred embodiment of the present invention, the position denoted by pitch angle B (FIG. 9) should correspond to the optimal flight characteristic pitch angle. Such information is typically required when setting-up a rotor system for any type of conventional fixed pitch autogyro, and methods for calculating such angles are well-known in the art.

Many rotor blade manufacturers also provide such information in support of their products. In the context of the present invention, knowledge of such a pitch angle is important as it ensures that the collective pitch mechanism of the present invention can be suitably adjusted so as to reproduce substantially the same flight performance as a conventional fixed pitch autogyro, but which also has the added capability of being able to take-off vertically. In this context; a conventional fixed pitch autogyro which has subsequently been retrofitted with a rotor head of the present invention and which utilises the same model and design of rotor blades, should fly sustainably with said rotor blades operating at the same pitch angle as the aircraft before having its rotor head upgraded. Depending upon the type of rotorcraft being considered and the design of its rotor blades, the optimal flight characteristic pitch angle could range from around 1.5 to 6 degrees, i.e. 1.5, 2, 2.5, 3, 3.5, 4, 4.5, 5, 5.5, 6 or 6.5 degrees, or at any point between. Whilst a value of 3.5 degrees is known to be utilised in some instances, a rotor blade having an NACA 8-H-12 profile will typically operate with the optimal flight characteristic pitch being set to around 2 degrees.

The terms “prerotator” and “prerotator mechanism” as used herein relate to any device that provides a means for enabling the rotor blades to be rotated around their main axis of rotation prior to take-off. Similarly the terms “prerotate”, “prerotating”, “prerotated” and the like, refer to the use of a prerotator in order to rotate the rotor blades prior to take-off. Typically the device is in the form of torque transmission device which transmits torque from the main engine to the rotor head in order to drive the main rotors blades prior to take-off, and which is completely disengaged before take-off. Alternatively, rotor blades which have been fitted with rocket engines at their tips have also been successfully tested and utilised in order to prerotate the rotor blades of an autogyro. Typically a prerotator should allow the rotor blades to be prerotated to a speed in excess of 100 rpm, preferably between 200 and 800 rpm, more preferably between 300 and 600 rpm, yet more preferably between 300 to 550 rpm, or which is especially preferred to be in the range of from 350 to 525 rpm. Any suitable method of prerotating the rotor blades should therefore be utilisable in conjunction with a rotor head of the present invention. The use of such prerotator mechanisms greatly reduces the length of runway required to achieve flight, and when used in accordance with the present invention, the length of runway required can be further reduced. Moreover, given a sufficiently powerful prerotator mechanism, ‘jump’ take-off is also achievable when utilising the rotor head of the present invention. Many different types of prerotator mechanisms are known in the art, and the most preferred type include a torque transmission device which transfers power from the main engine in order to prerotate the main lift rotor of the aircraft. Such a prerotator mechanism may comprise a variety of alternative couplings; whilst hydraulically operated couplings are amongst the most common, electric couplings are also known in the art (including those as disclosed in US2012/0025011), prerotator mechanisms that comprise a pneumatic coupling are also particularly attractive and light-weight (including those as disclosed in US2012/0181378) (the contents of US2012/0025011 and US2012/0181378 are incorporated herein by reference).

The term “centrifugal pitch stop” as used herein is defined as a mechanical component that comprises one or more centrifugal plates that move in response to rotation about a central axis. The centrifugal pitch stop in its “activated state” blocks the path of an object that is trying to move through the pitch stop's inner portion, or else conversely it can be manufactured such the centrifugal pitch stop blocks the path of an object containing it from passing through the centre of another object. When the centrifugal pitch stop is in its “deactivated state” there should be no obstruction. Similar mechanisms are commonly used in centrifugal switches for electrical circuits/powertool safety mechanisms, however the term “centrifugal pitch stop” as used herein specifically relates to a component which is designed/configured to have an activation point of between 100-500 revolutions per minute (rpm). More preferably the component should have an activation point of between 100 and 400 rpm, more preferably between 150 and 320 rpm, yet more preferably between 200 and 300 rpm, and which is especially preferred to be between 250 and 290 rpm. At rotations lower than the above mentioned activation point, the centrifugal pitch stop would normally be in its deactivated state. The centrifugal pitch stop can be configured to the desired rpm range utilising a suitable spring biased mechanism, and/or suitable weights and/or suitable magnets, in combination with suitably sized and shaped centrifugal plates. It is especially preferred that each centrifugal plate is in the form of a weighted lever and which comprises one or more weights located towards the distal end of the centrifugal plate. Whilst there is typically a small difference in rpm between the activation point of the centrifugal pitch stop and its deactivation point, it is desirable that such a difference is kept minimal and ideally there should be no more than 100 rpm difference between the centrifugal pitch stop's activation point and its deactivation point, and preferably no more than a 50 rpm difference. In accordance with the present invention, a centrifugal pitch stop mechanism therefore has i) a state of activation/activated state, ii) a state of deactivation/deactivated state, iii) an activation point and iv) a deactivation point. In accordance with the present invention, the state of activation should be dependent upon the rotational speed of the rotor blades which was in effect the last time the control means was operated. For the activated state; this state should always be obtained whenever the control means for the collective pitch mechanism is operated when the rotational speed of the rotor blades is greater than the activation point of the centrifugal pitch stop. The role of the deactivated state is not so critical, and whilst it may be preferable to ensure that the deactivated state can only be obtained when the control means is operated with the rotational speed of the rotor blades being less than the deactivation point; the centrifugal pitch stop could equally be designed such that when the rotational speed of the rotor blades drops below the deactivation point, the centrifugal pitch stop automatically attains its deactivated state (irrespective of whether a control input is applied). Whilst this deactivation behaviour really comes down to a personal choice during the manufacturing process, both of these aspects of deactivation behaviour are to be seen as belonging to the spirit of the present invention. In accordance with a preferred embodiment of the present invention, the centrifugal pitch stop comprises three main components: the centrifugal plates (100), the pitch stop (101) and the weight (102) see for instance FIG. 19.

The term “activation point” as used herein is defined as being the minimum rotational speed of the centrifugal pitch stop/rotor hub that can be utilised in order to set the centrifugal pitch stop in its activated state when the control means is operated. As the rotor rotates about its rotor axis, it is only when the rotor rpm is above the activation point, and with the control means of the present invention being operated that the centrifugal pitch stop can be placed in its activated state.

The term “deactivation point” as used herein is defined as being the maximum rotational speed of the centrifugal pitch stop/rotor hub that may be utilised in order to set said centrifugal pitch stop in its deactivated state when the control means is operated. When the rotor rpm is above the deactivation point the centrifugal pitch stop cannot be placed in its deactivated state. However when the control means is operated at a rotor speed that is below the deactivation point, the centrifugal pitch stop must attain its deactivated state.

Rotorcraft are known to be available in a wide variety of configurations, shapes, sizes, and can typically accommodate anywhere from 1-10 occupants. The present invention is intended to cover all such rotorcraft which have been fitted with a rotor head designed and manufactured in accordance with the present invention; this therefore includes without limitation single seat aircraft, two seater aircraft (including those configured in either a tandem or side by side arrangement), 3, 4, 5 or 6 seat aircraft, as well as larger aircraft that can seat 8 or more occupants. In the case of autogyros, single and two seat aircraft are especially important, but the present invention is also intended to cover larger autogyros that can accommodate, 3, 4 or more occupants also. The present invention is also intended to cover rotorcraft which are functional scale models including those which can be operated by radio controlled means and the like.

Notwithstanding the above, the rotor head of the present invention could also be utilised by rotorcraft in which the rotor blades are either fully or partially powered in flight. U.S. Pat. No. 4,653,705 (the contents of which are incorporated herein by reference) for instance relates to a rotorcraft, in which a certain amount of power from the engine is diverted to power the rotor blades in flight. Alternatively, and since the pitch bar, pitch horns and its associated bearings of the present invention can be connected to the rotor blades from either above or below the horizontal plane; it would equally be possible to develop a helicopter like aircraft which incorporated a rotor head having two counter rotating blades which incorporated two independent rotor hubs each prepared in accordance with the present invention, such a rotor craft as described for instance in US2010/0001120 could therefore be improved/simplified in view of the present invention.

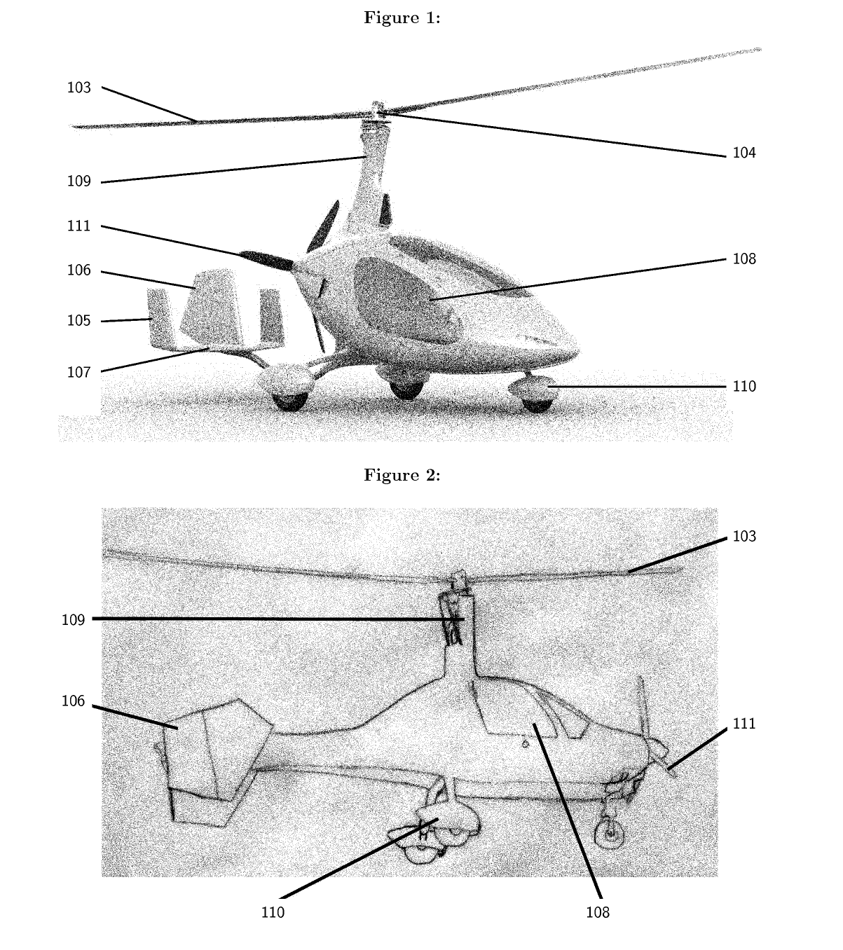

With reference to the prior art Cavalon Autogyro (as manufactured by AutoGyro GmbH of Germany) as presented in FIG. 1 for instance, an autogyro conventionally has two or more rotor blades (103) connected to a rotor head (104) which is unpowered in flight operating solely on the principal of autorotation. Most autogyros typically include one or more vertical stabilisers (105) and a rudder (106), as well as one or more horizontal stabilisers (107). Suspended below the rotor head is the fuselage and cockpit (108), which is connected to the rotor head (104) through the mast (109). Some form of undercarriage (110) or flotation device is also usually provided. Flight is achieved utilising the thrust which is generated through use of a propeller (111). Most modern autogyros are designed in a pusher type configuration, where a propeller is located towards the rear of the aircraft. Alternatively, some autogyro manufacturers have focused on positioning the engine/propeller at the front of the aircraft in a tractor type configuration as demonstrated by the prior art Phenix autogyro shown in FIG. 2. Whilst pusher type aircraft currently dominate the marketplace, there still remain many safety concerns over this type of configuration due to their longitudinal stability. Whilst these stability issues have now largely been resolved in modern aircraft such as those manufactured by Autogyro GMBH and Magni Gyro for instance by the use of a large correctly positioned horizontal stabiliser; the tractor type configuration has the potential to be aerodynamically the most stable. In recent times, where aerodynamically stable and balanced aircraft are being manufactured in purpose built factories (as opposed to home build/kit type aircraft), many safety issues associated with the aircraft design are now largely historical and have now been resolved. In addition to the factory built Cavalon and Phenix autogyros as shown in FIGS. 1 and 2, Autogyro GMBH of Germany also produce a number of other impressive autogyros models including the Callidus and MTOSport models. Similarly Magni Gyro of Italy also produce a number of impressive and stable aircraft including the Magni M24 Orion.

In spite of the increasing popularity of autogyros in recent years, much focus has drifted away from manufacturing autogyro aircraft with collective pitch control mechanisms. Both of the representative prior art aircraft shown in FIGS. 1 and 2, as well as all of those currently produced by Autogyro GmbH and Magni Gyro being only available in a fixed pitch configuration with no jump-take off capability. To date, the lack of success of the jump take-off concept has therefore been largely attributable to the complexity, reliability, expense and associated servicing costs and requirements of such mechanisms. At the current time, one of the key attractions of manufacturing autogyros not least as sports aircraft is that they are significantly cheaper to own and operate than a similarly sized helicopter. Any successful autogyro fitted with a pitch control mechanism must therefore remain highly competitive in cost, performance, reliability and safety to a helicopter. It is therefore another aim of the present invention to be able to provide a jump take-off rotor head that can be produced in kit form, and which has also been specifically designed to enable it to be retrofitted to the various models of factory built autogyro that have been under production and development. This includes a range of aircraft models designed and produced by the major manufacturers including Autogyro GmbH (including for instance the MTOsport, Cavalon and Calidus models), Magni Gyro (including the M14, M16, M18, M22, M24 models), Phenix Autogyro, Celier Aviation (especially the various models of the Xenon autogyro), Rotortec GmbH (including the various Cloud Dancer Models), Aero-Sport International (including the Kahu Autogyro models), ELA Aviacion (including the ELA 07, ELA 08 and ELA 09 models), Hummingbird Gyrocopter (including the various H1 models), Arrow Copter (particularly the AC20), Sport Copter International (including the Sport Copter models, Lightning and Vortex models), Groen Brothers Aviation etc. etc.

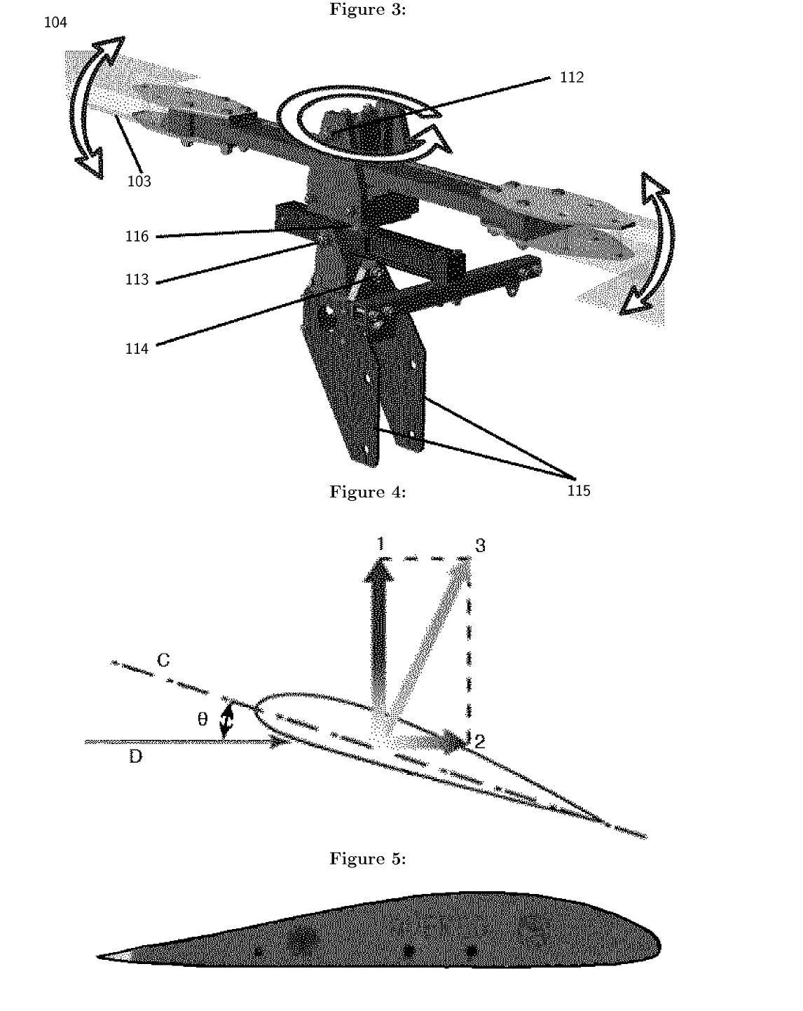

With reference to FIG. 3, a conventional fixed pitch semi-rigid rotor system (104) similar to those used on the aircraft of FIGS. 1 and 2 is shown (for the sake of simplicity no prerotator mechanism is shown). Such a rotor design as shown in FIG. 3 is perhaps the most simplistic, reliable and elegant of any rotor head that has been developed to date. The main feature of this system is that the rotor blades (103) are attached to the rotor head through the teeter bolt (112). The entire aircraft being suspended like a pendulum through the teeter bold, teeter hinge and universal joint hinges (113) and (114), with the main aircraft mast (109) being attached to the rotor head through the mast plates (115). In forward flight when the rotor blades autorotate about the rotor axis which is facilitated through the rotor head bearing (116); due to the inequality of lift between the advancing rotor blade and retreating blade, the rotor head is continuously flapping about the teeter axis mediated through the teeter hinge/teeter bolt (112). Such a rotor head however has no means for controlling the collective pitch of the rotor blades, and without an exceptionally strong headwind and/or a powerful prerotator mechanism the aircraft requires the use of a runway, and some significant ground roll to achieve flight. Even when a powerful prerotator mechanism is fitted, and depending on the flight conditions and aircraft, it often takes in excess of 100 m of runway to achieve takeoff with an autogyro fitted with such a fixed pitch semi-rigid rotor head. In order to significantly reduce such a take-off distance and in accordance with the present invention, a means for adjusting the collective pitch of such a rotor system is provided.

FIG. 4 shows a cross section of a typical aerofoil with a pitch angle q, wherein: (1) represents the amount of lift; (2) is the amount of drag; and (3) is the resultant force. In accordance with the present invention, when the chord line (C) of the rotor is approximately in plane with the direction of airflow (D); the collective pitch angle (q) is at the minimised drag collective pitch angle, and the rotor experiences minimal drag, with negligible lift being generated. In this state, it is relatively easy to rotate the rotor blades about their rotor axis, and optimal and most efficient use of a prerotator can be made. In this way it is possible to ‘charge’ the rotor blades giving them at least as much rotational energy as would be required for flight once the pitch angle is subsequently increased. Depending upon the power of the prerotator/engine, gear ratio and certain other factors as known in the art, the rotor blades can be prerotated at the minimised drag collective pitch angle to speeds in excess of 1500 rpm. It is usually however more preferable in the interests of safety, part wear, and energy efficiency etc., to prerotate the rotor blades to a lower rotational speed such as around 1-3 times the typical rotational speed of the rotor blades required for flight, and more preferably between 1.0-2.5, and ideally between 1.2-1.7 times the typical rotational speed of the rotor blades required for flight. However, any suitable rpm speed may in theory be utilised such as for instance between 100 and 1500 rpm, more preferably between 100 and 800 rpm, more preferably between 200 and 600 rpm, yet more preferably between 350 and 500 rpm. Once the autogyros rotor blades have been charged/prerotated to their intended speed for take-off, the prerotator mechanism should be disengaged, and the angle of attack/collective pitch angle of the rotor blades can be increased. At this point, any increase in the collective pitch angle of the rotor blades will immediately generate lift; if enough lift is generated, it can ‘jump’ the aircraft into the air. The amount of lift generated being dependent not least upon both the rotational speed of the rotor blades and also their angle of pitch. If sufficient rotor rpm can be provided, and in order to achieve an optimal jump takeoff, it is ideal to increase the collective pitch of the rotor blades above their optimal flight characteristic pitch; the collective pitch angle of the rotor blades can then be subsequently reduced once the jump takeoff has been accomplished. For a jump takeoff, any initial increment in collective pitch angle q of up to 18° can therefore be utilised, depending upon the prerotational speed, shape/efficiency of the rotor blades, and weight of the aircraft. Whilst it may be possible to increase the collective pitch angle (q) anywhere up to 18° or more for take-off with certain aerofoil profiles, it is more preferable to increase the pitch to an angle ranging anywhere between 2 and 10 degrees, or between 3 and 9 degrees, including the pitch angles of 2, 2.5, 2.75, 3, 3.25, 3.5, 4, 5, 6, 7 or 8 degrees or at any point between. Once the collective pitch of the rotor blades has been increased, the propeller must be engaged to maintain forward momentum, and also to maintain an airflow over the rotor blades. At this point, the collective pitch of the rotor blades should be reduced, and said reduction in pitch should preferably result in the pitch of the blades being reduced automatically to their optimal flight characteristic pitch. In this way, sustained flight can be achieved. Alternatively, if a jump take-off is not required/intended, the rotor head of the present invention will also enable the aircraft to perform in a similar fashion as a conventional autogyro and enable the rotor blades to be prerotated from stand-still to a prerotation speed of anywhere between 100 and 350 rpm utilising the rotor blades at either the minimised drag collective pitch angle or the optimal flight characteristic pitch angle, and such behaviour could also be useful not least for training purposes.

In accordance with the present invention a wide range of aerofoils may be utilised, and this includes aerofoils that are either symmetrical or asymmetrical in cross-section. Rotor blades which incorporate an efficient profile such as a NACA 8-H-12 profile, a NACA 9-H-12 profile or a Boeing VR-7 profile etc. are most preferable, with profiles such as the Boeing VR-7 and NACA 8-H-12 profiles being especially preferred. Whilst symmetrical rotor blades have often been utilised on helicopters because they are more adaptable to a wide range of pitch angles, asymmetrical rotor blades are generally preferred. Conventional autogyros often use rotor blades which are asymmetrical in cross-section, as they are more efficient in flight when operating at a specific pitch angle. FIG. 5 for instance shows an aerofoil profile similar to the NACA 8-H-12 and as utilised on the Phenix autogyro presented in FIG. 2 for instance. In addition to having a certain profile, the rotor blades themselves may optionally further comprise a slight twist along their length, in order to further improve their lifting efficiency. In accordance with the present invention, both straight and twisted rotor blades can be utilised. Indeed, one of the advantages of the present invention is that it can be used in accordance with a wide range of commercially manufactured rotor blades. Suitable blades being manufactured by companies such as Averso and Vortech, Inc. to name just a few, as well as by many of the main autogyro companies mentioned previously. The weight of the rotor blades also has a big effect on the rotorcrafts jump take-off performance. Heavier rotor blades are capable of storing a greater amount of kinetic energy which is ideal for use in the jump take-off concept, and a slower prerotational speed can therefore be utilisable. Lighter rotor blades however are often more advantageous for flight performance, but they typically require a higher prerotational speed to achieve the same degree of jump take-off. Alternatively, the rotor blades can be weighted at the tips to provide extra inertia, but without adding substantial weight to the aircraft. Without wishing to be bound by theory, it is thought that this difference is likely to be due to the difference in inertia potential between the different weights of rotor blades.

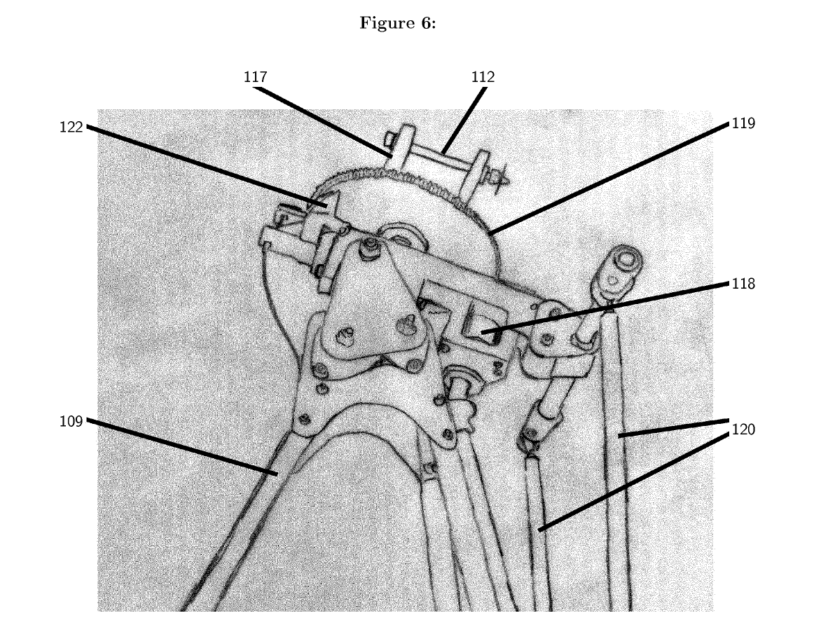

FIG. 6 shows an example of the typical directional control means that are utilised on many prior art autogyros for controlling the pitch and roll of the aircraft, and which are equally suitable for use in accordance with the present invention. In this example, the rotor blades (which have been omitted for the sake of clarity) are attached to the cheek plates (117) through the teeter bolt (112). In a similar way to the present invention, the rotor blades can be prerotated through a prerotator mechanism (118) which can be engaged with the rotor ring gear (119) which is physically connected to the cheek plate (117) holding the teetering hinge/hinge bolt (112). The rotor head itself being connected to the mast (109) through a universal joint (also as shown in FIGS. 3 (113) and (114)) with pitch and roll being controlled and determined by the control rods (120) (the workings of such directional control means are further detailed in U.S. Pat. No. 5,304,036 the contents of which are incorporated herein by reference). Other mechanisms for controlling the pitch and roll of the aircraft such as the cable mechanism developed for the Calidus and Cavalon autogyros (as manufactured by AutoGyro GmbH in Germany) are also suitable for use with the collective pitch mechanism of the present invention. Suitable prior art rotor head directional control means are also disclosed in EP2279943 and RU2313473. The rotor heads disclosed in these latter two documents each comprises of an alternative universal joint configuration and its associated hinges (113) and (114). The disclosures of EP2279943 and RU2313473 also include a collective pitch mechanism that features a torsion plate (121) rather than using feathering hinge bearings. Whilst many of the concepts and features of the mechanisms disclosed in EP2279943 and RU2313473 are directly transferable and utilisable in accordance with the present invention, the disclosed mechanisms do not include the novel centrifugal pitch stop mechanism which is critical to the present invention and the performance enhancements that it provides.

In addition to the above directional control means, the rotor head may also incorporate a rotor brake (122) which can lock the position of the rotor blades when parked. In a particularly preferred embodiment of the present invention, the rotor brake can also be utilised/adapted to allow the speed of the rotor blades to be quickly reduced anytime the aircraft is on the ground, but particularly after landing.

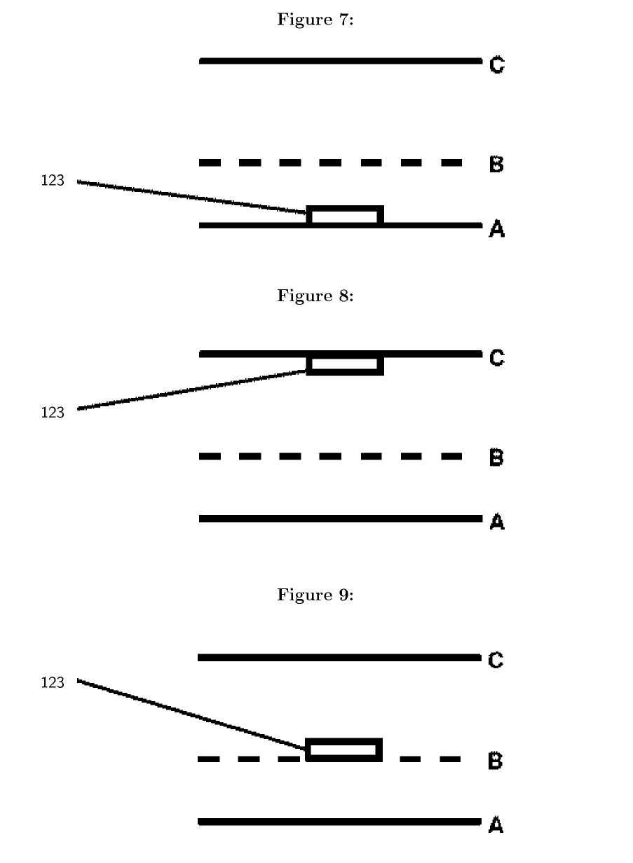

FIGS. 7, 8 and 9 detail the relative positions (not to scale) of a pitch mechanism when designed and used in accordance with the present invention. As stated above a ‘jump’ take-off is achievable when the rotor blades are charged with sufficient kinetic energy at the minimised drag collective pitch angle. This is represented in FIG. 7, by the collective pitch bar (123) being set to a position which determines the minimised drag collective pitch angle represented by point A. Once the rotor blades are prerotated with sufficient kinetic energy, the ‘jump’ is achieved by releasing this kinetic energy in the form of lift by increasing the pitch of the rotor blades utilising the pitch control mechanism of the present invention. This results in the collective pitch bar (123) being moved past point B all the way to stop at point C as shown in FIG. 8 which defines a high pitch/high lift/high drag/optimal jump take-off collective pitch position. Now the aircraft is airborne the speed of the rotor blades will slow quickly, and the aircraft will sink back to the ground unless airspeed is maintained and rotor drag is reduced. To this end, additional thrust must be provided at this point through the use of the autogyros propeller. The pitch of the blades should also be reduced to the optimal flight characteristic pitch of the aircraft, and which is achieved simply by removing the control input provided by the control means of the present invention. By removing the control input, the pitch of the rotor blades is automatically reduced collectively by the rotor head, and the position of the collective pitch bar (123) moves to and stops at point B as shown in FIG. 9. Point B is achieved and maintained by the mechanism of the present invention through the use of the centrifugal pitch stop. The mechanism of the present invention thus maintains and sustains flight of the aircraft with the collective pitch of the rotor blades being held fixed at the optimal flight characteristic pitch (B). Whilst it may be possible to utilise the collective pitch mechanism of the present invention during landing, landing of a conventional fixed pitch autogyro typically involves relatively little ground roll, and there is therefore often little advantage to be gained through the use of a collect pitch mechanism during landing. Once the rotorcraft has landed, and the speed of the rotor blades has reduced below the activation point and/or deactivation point of the centrifugal pitch stop; a brief and partial activation of the collective pitch mechanism by the pilot is usually sufficient to release the centrifugal pitch stop, thus allowing the collective pitch mechanism to automatically return the blade pitch back to the minimised drag collective pitch angle represented by point A, and the whole jump take-off process can therefore be repeated indefinitely. It is therefore apparent that other advantages of the present invention therefore include the mechanism being easy to operate, safe and reliable, as well as being easy to reset after landing without the need for the rotor blades to be brought to a complete standstill. In accordance with the above, a rotor brake may also prove to be useful. A rotor brake enables the speed of the rotors to be reduced more quickly, and this therefore enables the speed of the rotors to be reduced below the activation point and/or deactivation point quickly in preparation for another immediate jump take-off.

In a preferred embodiment of the present invention, the collective pitch angle of the rotor blades when at point C should not be more than 4° greater than the optimal flight characteristic pitch angle B. When such a condition is met, optimal jump take-off performance can be achieved, whilst simultaneously minimising any risk to the aircraft from wind effects when the collective pitch mechanism is operated on the ground (particularly when the mechanism is reset back to point A). In an especially preferred embodiment, the collective pitch angle of the rotor blades when at point C should range from 0.5-2° greater than the optimal flight characteristic pitch angle B. However, in an alternative embodiment, it may equally be desirable to design/configure/setup pitch stops B and C such that point C is only marginally greater than point B. In this way point C allows the centrifugal pitch stop to be released, but produces no significant increase in collective pitch of the rotor blades. Such a setup would be particularly useful for instance when the aircraft is intended to perform a series of jump take-off manoeuvres in quick succession, and/or where the aircraft is likely to be operated under more extreme wind conditions.

It is also to be emphasised that the rotor head should be designed to ensure its safe and smooth operation across its full range of travel, particularly when the collective pitch mechanism travels from point A to C, point C to B, point B to C, point C to A etc. and/or at any point in between. Furthermore, in some aspects of the invention it is particularly preferred that the mechanism is designed such that the movement from pitch angle C to pitch angle B is particularly smooth, wherein said movement from pitch angle C to pitch angle B may be prolonged in duration such that after release of the control input, it may take anywhere from between 0.1 seconds to 10 seconds to travel from pitch angle C to pitch angle B, more preferably to take between 1 and 4 seconds from release of the control input to arrive at pitch angle B. This ensures that upon release of the control input after take-off, there is no sudden loss of lift as the rotor blades reduce in pitch. Any means for enabling this prolonged motion can be accommodated, including for instance being facilitated through an electronic means in conjunction with the control means. Alternatively the prolonged motion could be facilitated through some mechanical means, including the use of viscous oils at the interfaces of some of the moving components. In a preferred embodiment, and wherein if the control input is mediated via a hydraulic system, or a pneumatic system, the rate of pitch change/prolonged motion can for instance be determined and/or adjusted by controlling the rate of flow of the fluid/gas pressure in the hydraulic or pneumatic system.

Another advantage of the present invention is that the risk of developing blade stall can effectively be eliminated. Blade stall typically occurs when the pilot attempts a rolling take-off when the rotor rpm is not sufficiently high. The combination of high air-speed, and low rotor rpm causes the retreating blade to stall and the aircraft typically rolls over to one side. Whilst blade stall may be averted by good pilot training, an autogyro which performs a jump take-off utilising the rotor head of the present invention can be completely prevented from encountering such a problem. This is in part because the rotors rpm would already be prerotated to a very high rpm prior to attempting the jump take-off.

In the case where the present invention is activated through one or more electronic activation switches, the rotor head can be designed/configured to only allow the collective pitch of the rotor blades to be increased from the minimised drag position (A) when a number of important safety criteria have been met. For instance if the aircraft is fitted with a main electronics system and features a “Brake/Flight” switch (as conventionally fitted for instance on the Autogyro MTOSport by Autogyro GmbH), and the aircraft is set to ‘flight’ mode with the pilot depressing the activation switch for the collective pitch mechanism of the present invention; the collective pitch mechanism will only be activated when:

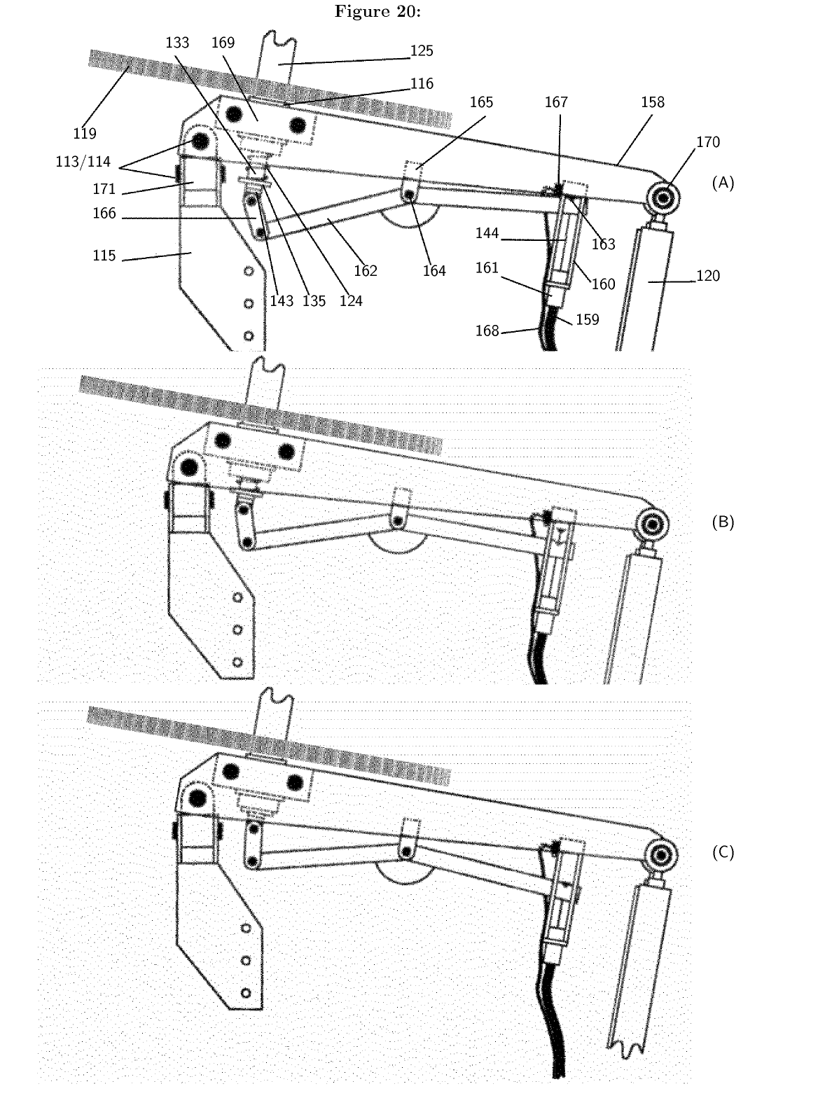

a) the pitch of the rotors is initially set to the minimised drag collective pitch angle (A) (and which may be determined by a micro-switch such as that shown in FIG. 20);

b) the rotor rpm is well above a minimum predetermined jump take-off rotor speed/activation point (such as being in excess of 300 rpm, preferably in excess of 350 rpm, more preferably being in excess of 400 rpm, and even more preferably being around 425 rpm) (wherein the actual rotor speed may be determined in real time utilising a conventional rotor speed sensor and its associated electronics);

c) the prerotator mechanism has been disengaged (which can be determined by another one or more micro-switches); and

optionally d) when the flight control stick is positioned in a more suitable central position (such as having been moved backwards from the fully forward position used for prerotation).

In this way jump take-off is still controlled by the pilot, but take-off can only be achieved when the aircraft has been operated safely and correctly.

Furthermore, when the aircraft is on the ground (and which may be set to ‘brake’ mode (as noted above)); the electronics could be setup to ensure that the activation switch for the collective pitch mechanism of the present invention can only be activated when the rotor rpm is below the deactivation point of centrifugal pitch stop (preferably with the rotor rpm being below 250 rpm). In this way, the collective pitch of the blades can be reset from the optimal flight characteristic pitch angle (B), ultimately to arrive at the minimised drag collective pitch angle (A) only when pitch stop (101) would be completely clear of the centrifugal plates. Operating the collective pitch mechanism at a lower rotor rpm also minimises the risk of the aircraft being blown over by a strong cross-wind as the collective pitch of the blades briefly increases above the optimal flight characteristic pitch angle (B). For the purposes of pre-flight checks; operation of the activation switch for the collective pitch mechanism of the present invention could also be accomplished when the rotor blades are stationary (including when the aircraft is set to ‘brake’ mode as discussed above).

Notwithstanding the above, the centrifugal pitch stop and collective pitch mechanism itself should be designed in accordance with the present invention such that irrespective of the rotational speed of the rotor blades, the centrifugal pitch stop must always allow the collective pitch bar (123) to pass unhindered from point A through to point C as shown in FIGS. 7 and 8. Conversely, the centrifugal pitch stop must always prevent collective pitch bar (123) from returning to point A from point C when the rotational speed of the rotor blades is above the activation point of the centrifugal pitch stop. In the interests of safety, it is also desirable that the activation point of the centrifugal pitch stop is less than the minimum rotational speed of the rotor blades that is required for flight, i.e it should be less the minimum rotor speed required for sustainable flight. Typically the minimum rotor speed required for sustainable flight ranges from around 220-400 rpm. On an MTOsport autogyro for instance, flight cannot be recovered if the rotor rpm falls below about 280 rpm, with the minimum take-off rpm being typically around 350 rpm; for such an aircraft it would therefore be most preferable to ensure that the activation point is configured to be less than 350 rpm, and which should ideally be less than 280 rpm, and preferably in the range of 200-280 rpm, such that the activation point should be less than the minimum rotational speed of the rotor blades that is required for flying the rotorcraft. However, since the minimum rotational speed of the rotor blades that is required for flight is dependent upon the make, model and design of the rotorcraft, as well as being dependent upon wind conditions, weight of the aircraft and the pitch angle of rotor blades; the activation point of the centrifugal pitch stop is generally configured to be between 100 and 350 rpm, more preferably between 150 and 320 rpm, yet more preferably between 200 and 300 rpm, and which is especially preferred to be in the range of between 250 and 290 rpm. In this way, if the collective pitch mechanism becomes unintentionally operated in flight; provided the mechanism is released prior to the rotor blades loosing their required flight rpm, the centrifugal pitch stop will still automatically ensure that the pitch of the rotor blades returns to the optimal flight characteristic pitch. In a preferred embodiment of the invention, the activation means for the collective pitch mechanism is controlled electronically through a main activation switch, and optionally one or more electronic safety override and/or trim switches. One of the override switches could for instance be linked to the rotor rpm sensor in order to prevent the collective pitch mechanism from being activated when the rotor rpm is above the minimum flight rpm, and when the collective pitch of the rotors is already locked at the optimal flight characteristic pitch angle (B).

In another embodiment of the invention, it is also preferable that when there is no control input from the pilot, and irrespective of the rotor blades rotational speed, the collective pitch bar (123) can be held locked in place at point B by some suitable means such as a spring biased means (124). In this way even if the rotational speed of the rotor blades falls significantly below the deactivation point of the centrifugal pitch stop, the collective pitch of rotor blades remain held at their optimal flight characteristic pitch. However as soon as the collective pitch mechanism is activated by the pilot when the rotational speed of the rotor blades is below the deactivation point of the centrifugal pitch stop, the centrifugal pitch stop should release the collective pitch mechanism allowing the collective pitch bar (123) to automatically return back to point A. Such functionality gives the pilot direct control of the mechanism, allowing them to determine the most appropriate time for setting the collective pitch of the rotor blades utilising knowledge of the rotor blades rotational speed/rpm and prevailing wind conditions. Therefore, in addition to providing a jump take-off capability, the centrifugal pitch stop mechanism of the present invention also enables an autogyro to be flown, landed and perform take-off manoeuvres exactly as a fixed pitch autogyro and which may be beneficial not least for autogyro flight demonstrations and training purposes. Irrespective of how it is used, a quick activation of the collective pitch mechanism when the rotational speed of the rotor blades is below the deactivation point of the centrifugal pitch stop should always be sufficient to deactivate the centrifugal pitch stop and hence to allow the collective pitch of the rotor blades to automatically return to the minimised drag collective pitch angle as represented by point A in FIG. 7.

Although not expressly intended for use in landing purposes, a highly skilled pilot may be able to utilise the collective pitch mechanism of the present invention to reduce excess ground speed, and in order to further improve the performance of said aircraft. In this way vertical landing may be possible when it would otherwise be unachievable.

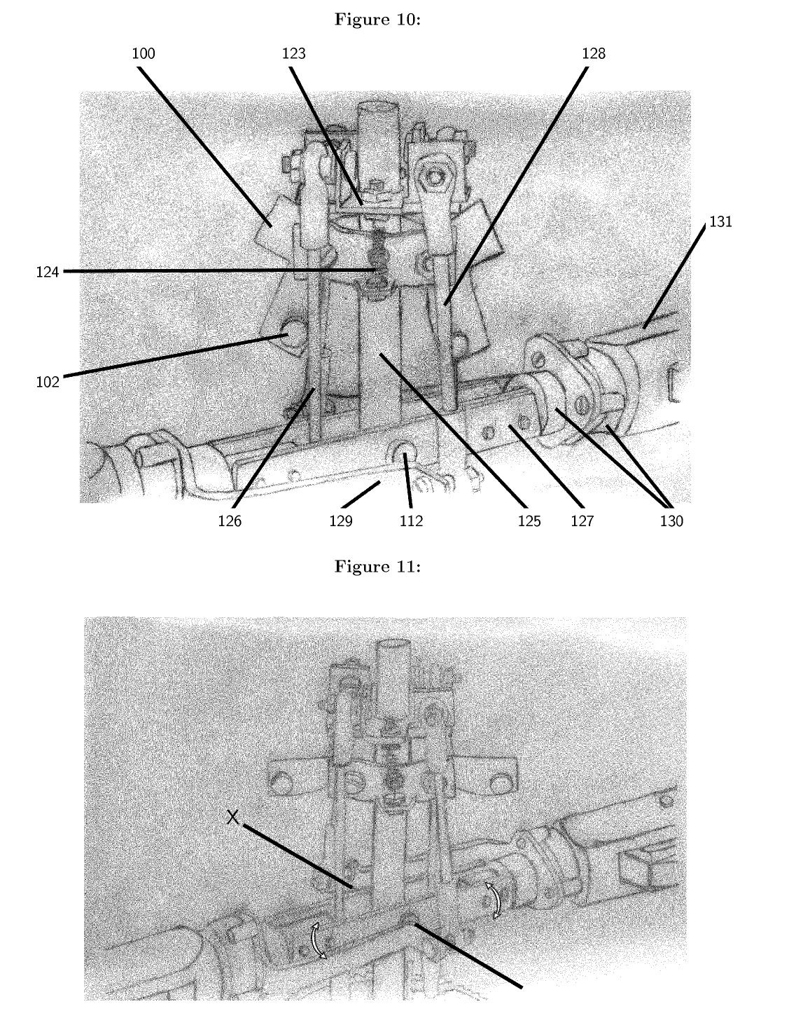

FIG. 10 shows a simple rotorhead which was developed in order to evaluate the potential of the present invention. 123 which is equivalent to the pitch bar in this embodiment, is able to move up and down the rotor hub (125) in response to a control input which is mediated through a pair of pushrods (126) which pass through a gap in the connective links (127) either side of the rotor hub (125). Pitch bar 123 is connected to the rotor blades through the horn links (128), pitch horns (129), feathering hinge (130) and rotor links/rotor blade attachment means (131). As noted above, parts (102) and (100) represent two of the key components of the centrifugal pitch stop. The rotor head mechanism also includes a spring biased means (124) which helps to lock the pitch bar at positions A or B when there is no control input.

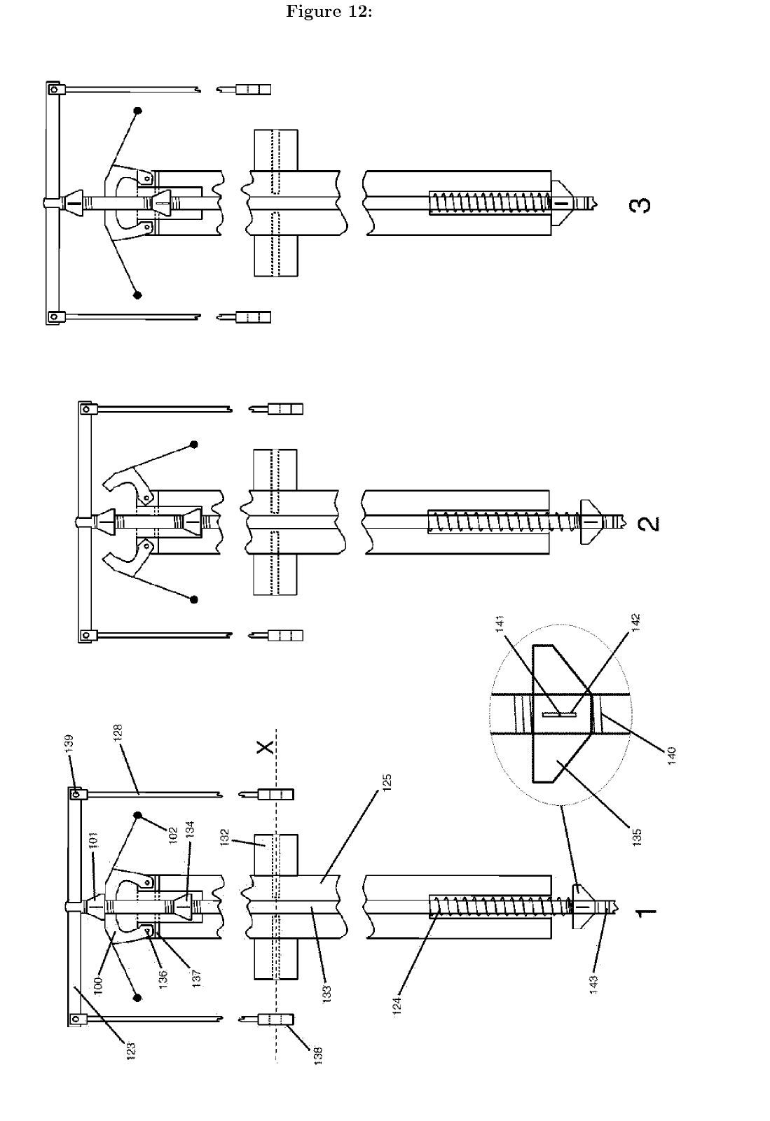

FIG. 10 shows the collective pitch mechanism with the centrifugal pitch stop being in its deactivated state with the rotor blades being held approximately at the minimised drag collective pitch angle. FIG. 11 shows the collective pitch mechanism with the centrifugal pitch stop being in its activated state.

With reference to FIGS. 10 and 11 for instance and starting in the deactivated state; as the rotor head/rotor blades rotate about the rotor axis, the centrifugal plates (100) and weights (102) begin to experience a centrifugal force. In this example, by about 200 rpm, the centrifugal plate is above its activation point and is pressed against components of the pitch bar (123). In this state however the pitch of the blades remains unchanged, for it is only when the collective pitch mechanism is activated through the pair of pushrods (126) does the collective pitch of the rotor blades actually change. In this example when the rotation speed of the rotor hub is above about 200 rpm, and with pushrods (126) being operated, the centrifugal pitch stop is in a state of activation with the pair of centrifugal plates (100) resting upon the rotor hub (125); the collective pitch of the rotor blades at this point however is determined by the length of travel of the pushrods (126) when they are operated. However, once the control input is released through the pair of pushrods (126), the spring biased means (124) ensures that 123 fully engages with the pair of centrifugal plates (100), and thus the collective pitch of the rotor blades is held at their predetermined optimal flight characteristic pitch. This position is as shown in FIG. 11, where the new position of the pair of centrifugal plates can clearly be seen.

In FIG. 11 the diagonal line marked (X) shows the approximate alignment of the teeter bolt (112)/teeter axis with the connections between the pitch horns (129) and the horn links (128). In another aspect of the present invention, when the rotor head is held at the predetermined optimal flight characteristic pitch by the centrifugal pitch stop, the teetering axis should be in exact alignment with the connective means between the pitch horns (129) and the horn links (128). When such a condition is fulfilled; as the rotor blades flap through the teeter hinge, there is absolutely no induced motion through the components of the collective pitch mechanism, as the pitch horns (129) and connective links (127) are able to flap in unison. This ensures that the rotor blades behave exactly in the same way as a fixed pitch autogyro, without introducing any additional vibration through the collective pitch mechanism. Moreover, by taking advantage of this aspect of the present invention, it is possible to simplify the construction of the collective pitch mechanism of the rotor head thus removing many of the additional parts as present on collective pitch mechanisms of the prior art. In this state, not only is it possible to avoid introducing any additional vibration through the collective pitch mechanism, but it also ensures that there is minimal wear on the additional components of the collective pitch mechanism. The feathering hinges for instance should remain completely static during flight, even as the rotor blades themselves are able to flap and/or teeter as they please. The collective pitch mechanism of the present invention should therefore have a much greater lifetime relative to a conventional collective pitch mechanism/rotor head for a helicopter. The associated running costs should also therefore be greatly reduced.

FIG. 12 shows a preferred rotor head design which has been prepared in accordance with the present invention. It is shown here as a cross section through the rotor hub (125), with the rotor attachments, rotor ring gear and rotor hub bearing being omitted from this drawing for the sake of clarity. The hub (125) itself is shown divided into its respective upper, middle and lower portions, the central portion housing a pair of securing means for a pair of teeter bolts. The teeter bearings being attached at point 132. In accordance with the best mode of performing the invention, the mechanism has been devised to incorporate a single internal pushrod (133) which replaces the external pair of pushrods (126) (as shown in the example of FIGS. 10 and 11). Pitch bar (123) is attached directly to the top of the internal pushrod (133), which is shown here incorporating three pitch stops (101), (134) and (135). This example further shows a pair of centrifugal plates (100) bearing suitable weights (102) at the extremity of each centrifugal plate. The components (100), (102) and (101) as shown here collectively form the three main key elements that make up the centrifugal pitch stop. Each centrifugal plate pivoting through bearing means (136) and being attached to a base plate (137). The pitch horns (129) (not shown) are to be connected to the end of the horn links (128) through the bearing means (138). Each of the two horn links (128) being connected to the pitch bar (123) through joint (139), which could for instance be a spherical bearing to allow the horn links (128) a certain amount of three dimensional freedom of movement. This examples also incorporates a spring bias means (124) within the bottom of the rotor hub (125). As shown in the insert (as exemplified in the case of pitch stop (135)), one or more of the pitch stops (101), (134) and/or (135) may be attached to the internal pushrod (133) on a screw thread (140) such that the position of each stop can be independently and suitably adjusted. Each of the stops (101), (134) or (135) can then be secured in place by a suitable means such as a locking nut, a locking pin or other suitable screw means which engages with the pushrod (133). An example showing the use of a locking pin is shown in this particular and representative example; whereby locking pin (141) is passed through slot (142) and engages and passes through a small hole in the pushrod (133), the pin then being secured tightly in place. At the base of the internal pushrod (133) there is provided a bearing (143) to which the connective means for the operation cable (144)/hydraulic/pneumatic control input should be attached.

Situation 2 as shown in FIG. 12 corresponds to the collective pitch of the rotor blades and the collective pitch bar (123) being set to the minimised drag collective pitch angle represented by point A (as discussed above, and as shown in FIG. 7). The centrifugal plates are drawn here showing the case when the rotational speed of the rotor blades is less than the deactivation point of the centrifugal pitch stop. Here, pitch stop (134) prevents the collective pitch of the rotor blades from going below their predetermined minimised drag collective pitch angle.

Situation 3 as shown in FIG. 12 corresponds to the collective pitch mechanism being under operation (point C in FIG. 8), with the control input pushing pushrod (133) to its upper most position. The centrifugal pitch plates are shown in their activated state as if the rotational speed of the rotor blades is above the activation point. When the control input for the collective pitch mechanism is released whilst the rpm of the rotor blades is still above the activation point of the centrifugal plates (100), the spring biased means (124) draws the internal pushrod (133) down, so that pitch stop (101) engages with the top of the centrifugal plates (100), thereby locking the collective pitch mechanism and holding the pitch of the rotor blades at their optimal flight characteristic pitch; this corresponds to situation 1 as shown in FIG. 12. The dashed line marked X once again demonstrates that the bearing means (138) is only aligned with the teetering axis when the collective pitch of the rotor blades is held at the optimal flight characteristic pitch.

In accordance with FIG. 12 and the best mode of performing the invention, the collective pitch mechanism is typically activated from the minimised drag collective pitch angle (A), by forcing the internal pushrod (133) upwards towards the top of the rotor hub (125), this in turn ultimately lifts the pitch horns (129) which are connected on the leading edge side of the rotor blades upwards, thus increasing the collective pitch of the rotor blades. However and conversely, it would be equally possible to construct the collective pitch mechanism so that it operates in reverse to that as shown in FIG. 12, with the pitch horns protruding from the trailing edge of the rotor blades, and with it being activated by having pushrod (133) pulled downwards towards the bottom of the rotor hub (125). If for instance the collective pitch control mechanism was manufactured such that spring biased means (124) works in reverse to that shown in FIG. 12, and actively tries to pull pushrod (133) upwards, then this would ultimately be prevented by pitch stop (134) which could be attached towards the lower part of pushrod (133) (such as in place of pitch stop (135) as shown in FIG. 12). In such a situation, the centrifugal pitch stop could still be located at the top of the rotor hub (125), but it would need to be constructed such that in its activated state it can prevent pushrod (133) from moving upwards under tension from spring biased means (124). Furthermore, in order to reduce the collective pitch angle of the rotor blades as pushrod (133) and pitch bar (123) are pushed upwards relative to the rotor hub (125), it would usually be simplest to ensure that the pitch horns (129) are connected onto the reverse side/trailing edge of the rotor blades. With such a mechanism in operation, the collective pitch of the rotor blades could be increased from the minimized drag collective pitch angle (A) to point (C) by lowering the position of the (133) and pitch bar (123) relative to the top of the rotor hub (125) (and which is the reverse operation of the mechanism as shown in FIG. 12). In this case it may be appropriate to substitute the weights (102) on the centrifugal plates with a spring bias means, and/or magnets so that they are able to work in opposition to the force of gravity.

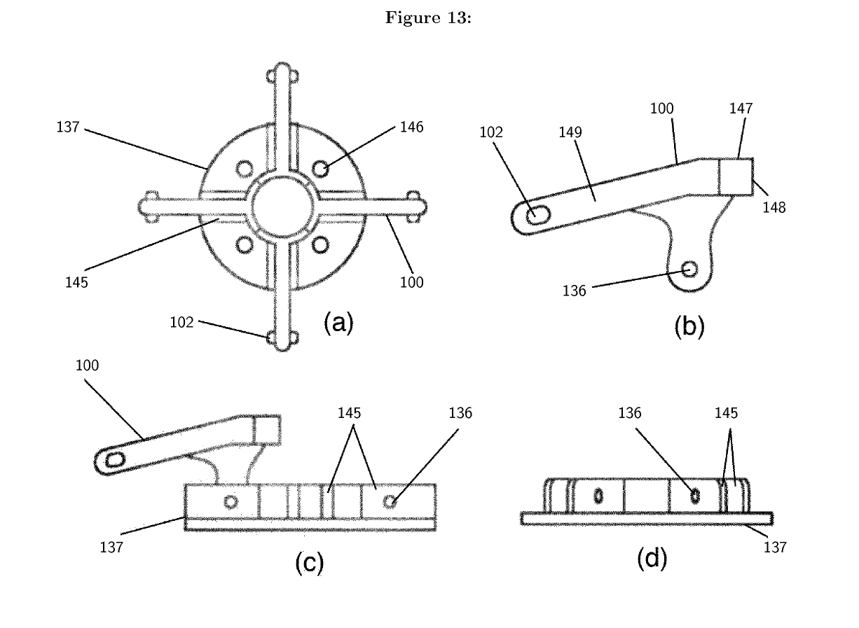

FIG. 13 show parts of a centrifugal pitch stop in more detail. The centrifugal pitch stop usually comprises one or more centrifugal plates (100), and it is preferred that the centrifugal pitch stop comprises at least two centrifugal plates, and more preferably between 2 and 6 centrifugal plates, with four centrifugal plates being particularly preferred for a two bladed rotor head, and three centrifugal plates being particularly preferred for a three bladed rotor head.

In FIG. 13; (a) shows a view as shown from above, looking down upon the key components of a centrifugal pitch stop when four centrifugal plates (100) are in their activated positions. The centrifugal pitch stop itself comprises a base plate (137) and several vertical plates (145). The base plate being bolted or otherwise attached to the top of the rotor hub (125) through securing holes such as those represented here by (146). In another embodiment the base plate is incorporated into the rotor hub and/or rotor ring gear. In order to further minimise wear on the components, and particularly the rotor hub (125), the centrifugal plates can be designed such that in the activated state, the centrifugal plates integrate collectively with one another to form a stable platform for pitch stop (101), without making any direct contact with the rotor hub (125).

With reference to (b) as shown in FIG. 13, a side-on view of a centrifugal plate (100) is exemplified. Such a centrifugal plate comprises a bearing means (136) and a weight (102), as well as having a two important contact surfaces (147) & (148), and a tail/distal section (149). In use, the activated state should only be obtainable when the control means is operated and when the rotational speed of the rotor blades is above the activation point. This can be configured by varying the mass of the weight (102) located at the tail end of each centrifugal plate (100). The activation point and deactivation point of the centrifugal pitch stop can also be configured by utilising centrifugal plates (100) which have a tail section (149) of the appropriate length, such that the weight is held an an appropriate distance from the central axis of rotation about the rotor hub. The shape of the weight (102) and/or the distal portion of the centrifugal plate are largely immaterial, however they can be suitably shaped to take into account the intended direction of rotation of the rotors for greater aerodynamic efficiency. These components can also be shaped so as to further enhance the autorotative capability of the rotor head. In the activated state, (147) represents the contact surface of the centrifugal plate (100) which makes contact with the bottom of pitch stop (101). Similarly, (148) represents the contact surface of the centrifugal plate (100) which may make contact with the other centrifugal plates (100) and/or the rotor hub (125). The contact surfaces (147) and (148) should therefore be designed and manufactured such that they are hard wearing, in order to reduce maintenance costs; this includes without limitation, the use of special hardened coating materials, suitable alloys, plastics such as PEEK and so on, as well as the use of smooth surfaces and/or additional bearings to reduce wear between the contact surfaces of the centrifugal plate (100) and the side of pitch stop (101).

With reference to (c) as shown in FIG. 13, this shows a side on view of the base plate (137), and which for the purposes of explanation shows one of the four centrifugal plates (100). Each of the centrifugal plates (100) being connected through bearing means (136) to a pair of vertical plates (145) which are directly attached to the base plate (137). This enables each centrifugal plate (100) to pivot on an axis about said bearing means (136).

(d) as shown in FIG. 13, shows another side view of the base plate (137), but which has now been rotated by 45° about the rotor hub axis. The base plate (137) may also include some holding means (not shown) for limiting the travel of the centrifugal plates (100), such that in the deactivated state all of the plates are held equally at the same angle relative to the horizontal position of the base plate (137). In this way vibration is minimised, particularly since all of the carefully balanced centrifugal plates (100) should have the same activation and deactivation point, and which should therefore activate and deactivate equally and simultaneously. The holding means can be designed to minimise the difference in rpm between the activation point and the deactivation point and may also comprise one or more magnets to aid in this purpose.

In a preferred embodiment of the present invention there should be no more than 100 rpm difference between the centrifugal pitch stop's activation point and its deactivation point, and preferably no more than a 50 rpm difference. The simplest way that this can be achieved for instance is by reducing the extent of travel that can be accommodated by the centrifugal plates between the activated and deactivated states. If for instance only a few millimetres of clearance is accommodated between the centrifugal plates (in their deactivated state) and pitch stop (101), the difference between the activation point and the deactivation point can be particularly small such as for instance being no more than 20 rpm.

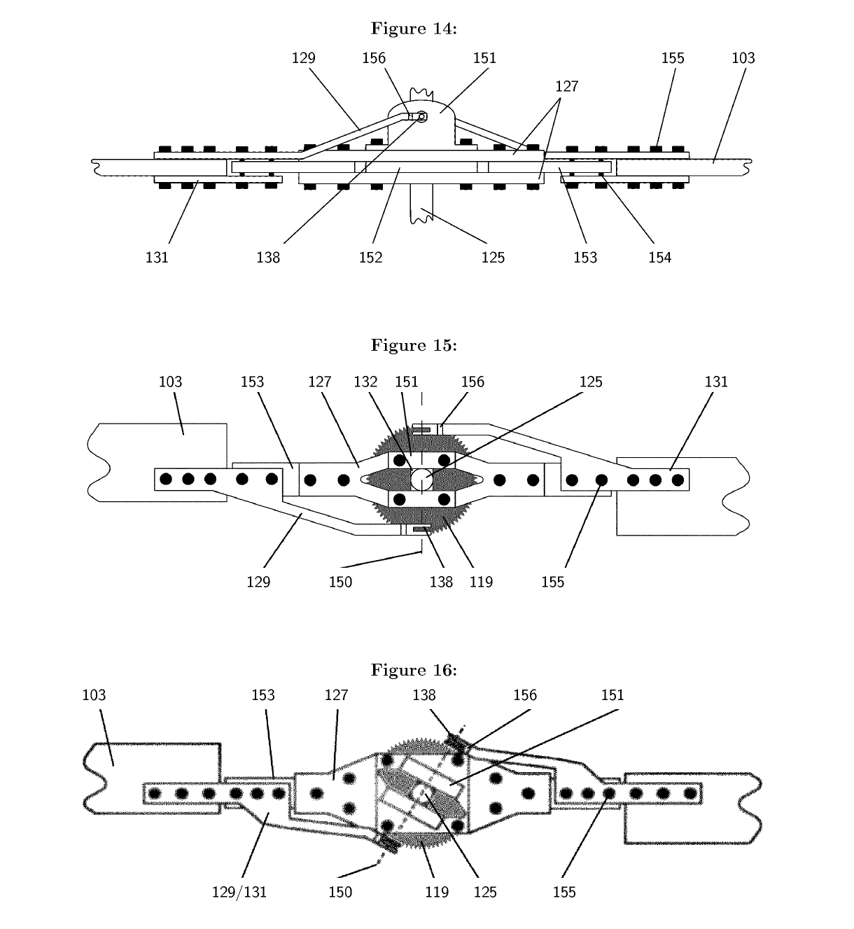

In FIGS. 14 and 15 an embodiment of the present invention exemplifying the attachment means for the rotor system is substantiated (wherein parts of the collective pitch mechanism including the centrifugal plates are omitted only for the purpose of clarity). FIG. 14 shows a side view of the rotor system as viewed along the axis of the teeter hinge, and when the pitch of the rotor blades is held at the optimal flight characteristic pitch. FIG. 15 shows a top down view of a similar rotor system, but which also includes the rotor ring gear (119) which helps to more clearly show the voids in the connective links (127) which allows the rotor system to teeter. In both FIGS. 14 and 15 it is also important to note that the axis of rotation through the teetering hinge (150) is approximately perpendicular to the rotor span/longitudinal axis of the rotor blades.

It is conventional for a two bladed semi-rigid rotor system to be underslung, i.e. the teeter bolt is typically located above the points of attachment for the rotor blades. The underslinging of a teetering rotor head is important as it helps to minimise aerodynamic forces and unwanted vibrations that occur as the rotor blades flap and thereby changes the rotors centre of gravity. This effect is well-known in the art, and also as discussed in detail in U.S. Pat. No. 4,115,031 (the contents of which are hereby incorporated by reference). As shown in FIGS. 14-16 the underslinging of the rotor system is also particularly important in the context of the present invention when a two bladed semi-rigid rotor system is designed. It is therefore important to note that even when utilising the underslinging concept, it is still possible to prepare a rotor head whereby the teetering axis (X) (which equates to (150) in FIGS. 15 and 16) remains in exact alignment with the key components of the collective pitch mechanism as discussed previously.

As shown in FIGS. 14 and 15; each teeter plate (151) is attached to the rotor hub (125) (a solid rotor hub being illustrated here for the purposes of clarity) through a connecting means and teeter bearing at point 132. The teeter plate (151) being attached to the rotor blades (103) through connective links (127) and supporting block (152); said connective links (127) being affixed to the blade bearing blocks (153) which house a multiplicity of spherical bearings (154) which are distributed along the pitch/feathering axis, to form the basis of the feathering hinge; the rotor blades (103) themselves being attached to the blade bearing blocks (153)/bearings (154) through rotor links/rotor blade attachment means (131), all of which are held together by any suitable adhesive means (155); suitable adhesive means could for instance include a number of rivets and/or nuts & bolts made from high tensile steel, stainless steel or any other impervious metal alloy. In place of at least some of the suitable adhesive means (155) it may be desirable to incorporate a lead lag/drag hinge, and/or means for adjusting the lead or lag of the rotor blades (similar to the as utilised on a Bell 206 helicopter for instance).

As exemplified in FIGS. 14 and 15; at least one of the rotor links/rotor blade attachment means (131) attached to each rotor blade comprises a pitch horn (129). The pitch horns (129) enable the collective pitch of the rotor blades to be controlled, and are attached to the horn links (128) (FIG. 12) through suitable bearing means (138). Bearing means (138) could either be a spherical bearing or a non-spherical bearing means; in the case where (138) is a standard non-spherical bearing, an additional bearing (156) could also be incorporated at the end of the pitch horn (and as substantiated in FIGS. 14 and 15). In flight, and when the rotor system of the present invention is set to its optimal flight characteristic pitch and when bearing (138) is aligned with the teetering axis (150), it is possible to sustain the optimum pitch of each individual rotor throughout a full 360 degree rotation of the rotor blade about its rotor axis, and which is independent of any flapping angle which can be mediated through the teetering hinge. Furthermore, in this special circumstance, the only bearing of the collective pitch mechanism subject to movement/vibration and potential wear is bearing (138).

Notwithstanding the design of the rotor head as exemplified in FIGS. 14 and 15, it must also be emphasised that rotor heads prepared in accordance with the present invention comprising a pair of cheek plates (117) and teeter bolt (112) assembly and which is consistent with the disclosure of FIG. 22 of U.S. Pat. No. 5,301,900 for instance are also particularly preferred. Depending upon how the mechanism is configured, the rotor head can also be designed such that the pitch horns (129) can be connected on either the leading edge side or the trailing edge side of the rotor blades. In either embodiment, it may also be preferable to incorporate the centrifugal plates into the rotor ring gear itself.

In another embodiment of the present invention, connective links (127), supporting block (152), blade bearing blocks (153) and spherical bearings (154) may be substituted with a torsion plate (121) which acts as the feathering hinge. Similarly, the presence of other optional hinges, such as the lead lag/drag hinges, coning hinges etc. may be accommodated through conventional bearing means, such as one or more roller bearing means. Alternative these optional hinges may comprise elastomeric bearings and flextures as commonly known in the art, particularly in the art of helicopter engineering. If a coning hinge is not present; in order to minimise stress upon the rotor blades, it is preferable to design the rotor head such that it defines a predetermined coning angle which is less than 180 degrees (FIG. 14 is drawn without a coning angle largely for the sake of simplicity only).

As substantiated in FIG. 16, and in another embodiment of the present invention; it may be preferable to fabricate the design of teeter plates (151) such that the axis of rotation through the teetering hinge is not perpendicular to the rotor span/longitudinal axis of the rotor blades (wherein in FIG. 16 parts of the collective pitch mechanism including the centrifugal plates are omitted only for the purpose of clarity). A rotor system manufactured in such a way has the benefit of reducing the teetering angle of the rotor blades as they flap during flight. Such a design therefore has the capability to reduce the amount of vibration exerted by the rotor head, as well as reducing any stresses that result from lead-lag forces. It is therefore a preferred embodiment of the present invention that the teetering hinge axis is not substantially perpendicular to the rotor span/longitudinal axis of the rotor blades, and is instead offset from the rotor span by between 50 and 89 degrees, preferably by about 60 degrees (and as shown in FIG. 16). In such a rotor design, and in accordance with FIG. 16, the pitch horns (129) can be designed to take such an offset in teetering angle into account. Importantly bearing means (138) can still be aligned with the teetering axis when the pitch of the rotor blades (103) is set to the optimal flight characteristic pitch angle.

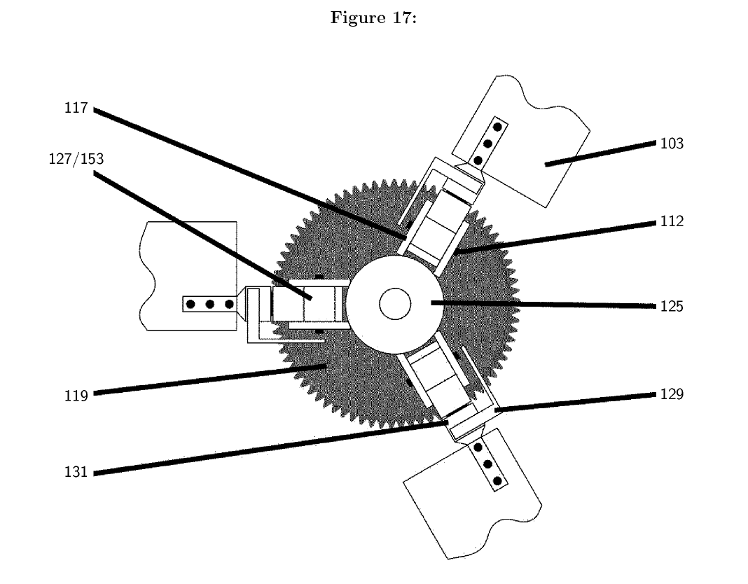

In this specification, it is a preferred embodiment of the present invention that the rotor head should be a semi-rigid rotor system which incorporates two rotor blades. The present invention however, is equally applicable to the manufacture a rotor heads that comprises three or more rotor blades including those presented in FIG. 17. Such rotor systems could be manufactured to include a flapping hinge, in place of the teetering hinge as is utilised on the semi-rigid rotor systems that are predominantly discussed herein. It may also be desirable to incorporate a degree of underslinging into the flapping hinge, and thereby removing the need to incorporate a lead-lag hinge (and in accordance with FIG. 17). The rotor system shown in FIG. 17 also includes conventional feathering hinges such as those used on helicopters such as the Bell 206, Robinson R22, Mosquito XE Ultralight etc. The feathering hinge bearings themselves being incorporated into the rotor links/rotor blade attachment means (131).

With a three, four or five bladed rotor system for instance, the mechanism of the present invention would remain largely unchanged from the two-bladed rotor system, only requiring additional links to connect each rotor blade to the pitch bar. Similarly, and assuming that the pitch angle changing means is configured correctly, and provides a degree of alignment with the flapping hinges (i.e. in a similar way to the alignment X as shown in FIG. 19); even with a rotor head comprising three or more rotor blades, it is still possible to ensure that during flight, there is substantially no induced cyclic pitch oscillation as the rotor blades revolve and teeter. I.e. the rotor head can be configured such that when the pitch angle of the rotor blades is set to the predetermined pitch angle which is suitable for sustained flight: i) the pitch angle of all of the individual rotor blades can be set equally and collectively to said predetermined pitch angle; ii) said pitch angle can be sustained throughout a 360 degree rotation about said rotor axis; and iii) said pitch angle which is suitable for sustained flight can be sustained independently of any motion which can be facilitated through said flapping hinge. In the case of a four bladed rotor system, rather than comprising four individual flapping hinges, it could alternatively take the form of a double teetering rotor system, incorporating two semi-rigid rotor systems, each set one above the other in a perpendicular arrangement (as utilised on the Cloud Dancer II by Rotortec GmbH for instance).

In some embodiments, the rotor head could also incorporate a lead-lag hinge and/or a coning hinge, all of which can be designed to work in conjunction with the collective pitch mechanism of the present invention. One of the consequences of having a mechanism that incorporates lead-lag hinges is that it can give rise to a phenomenon known as ground resonance. This could be a particular issue for larger jump-take off autogyros, as unlike with a helicopter, there would be less ability to control it. If lead-lag hinges are to be utilised, then there must also be adequate provision for a dampening means on the rotor head, as well as ensuring that any vibrations resulting from the undercarriage are easily isolated.

With a rotor head comprising three or more rotor blades, it is preferable not least for reasons of symmetry and balance to have a comparable number of centrifugal plates as there are rotor blades. The manufacture of rotor heads designed in accordance with the present invention which comprise three or more rotor blades connected to each hub, but which comprises only two centrifugal plates can certainly be achieved; however it is usually more preferable to ensure that for any rotor system, there are at least as many centrifugal plates on each hub as there are rotor blades. In particular the number of centrifugal plates on each rotor hub may be calculated using the formula: C=a×N; where C is the number of centrifugal plates, N is the number of rotor blades per hub, and a is an integer from 1-4. A rotor head that comprises three rotor blades, would therefore preferably comprise 3 or 6 individual centrifugal plates, whilst as many as nine or even 12 may be accommodated. Typically however, and irrespective of the number of rotor blades, it is not usually practical for each rotor head to comprise more than 12 centrifugal plates.

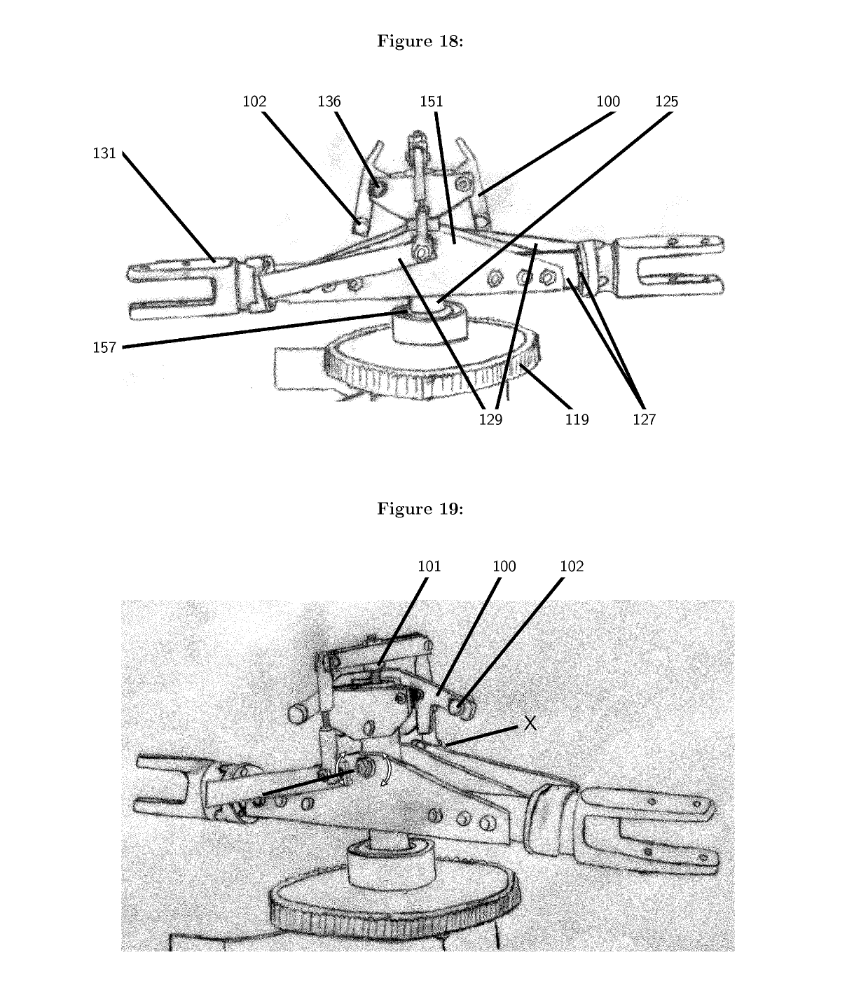

FIGS. 18 and 19 exemplify another rotor head which has been designed in accordance with the present invention. The design of this rotor head is very similar to that as discussed in FIG. 12. The arrangement and layout of the rotor head is also similar to that of a conventional two bladed helicopter including for instance ultralight helicopters such as the Mosquito XE Ultralight Helicopter, particularly in the arrangement of the teeter plates (151) relative to the rotor links/rotor blade attachment means (131) which comprise the feathering hinges (130) (not shown). FIGS. 18 and 19 also help to understand how the mechanism as shown in FIG. 12 can be utilised and connected to the rotor blades and rotor links/rotor blade attachment means (131). In this example, the connective links (127) are presented in the form of a cylindrical shaft which comprises two sections of different diameter. The larger diameter section is secured directly to the teeter plate (151), whilst the narrower section of the connective links (127) extend through and inside the rotor links/rotor blade attachment means (131) which house a pair of feathering hinge bearings. Whilst it is conventional for the rotor hub (125) to be connected directly to the rotor ring gear (119), this may not necessarily be the case. In this example the rotor ring gear (119) further comprises a unidirectional bearing (157). The use of a unidirectional bearing enables the rotor hub to be prerotated utilising the rotor ring gear, whilst also allowing the rotor hub to keep accelerating due to autorotation as air starts to flows over the rotor blades. In this way, the timing at which the prerotator is disengaged becomes less critical and may simplify the overall operation of the aircraft.

In FIG. 18, the rotor head is drawn showing it in its deactivated state, as can be seen by the position of the pair of centrifugal plates (100). It can also be seen that in this state, the pair of rotor links/rotor blade attachment means (131) are approximately parallel to each other, indicating that the rotor blades would be set to a reduced drag position.

In FIG. 19, the rotor head is drawn showing it in its activated state, as can be seen by the relative positions of the centrifugal plates (100) which are now engaged with pitch stop (101) with the position of the weights (102) being drawn outward due to the effect of centrifugal force which was experienced when the collective pitch control input was applied. In this example the activation point of the centrifugal plates were configured to be at about 315 rpm, ±5 rpm. FIG. 19 also highlights the situation which exists when the teetering axis is in exact alignment with the connective means between the pitch horns (129) and the horn links (128).

Another important consideration to make when designing a rotor head is to pay attention to the overall height of the aircraft. If the aircraft is too high, it may become more difficult to transport and/or house in an aircraft hanger. In accordance with the present invention, it may be preferable to locate the relative position of the centrifugal plates to be above the position of the teeter bolt, in this situation however, it is preferable to design the components such that any additional height is minimised. In other embodiments of the present invention, it is possible to locate the centrifugal plates below the position of the teeter bolt. This could be achieved for instance by integrating the centrifugal plates into the upper surface of the rotor ring gear (119). The pitch bar (123) could then be designed to exit the rotor hub (125) either above or below the position of the teeter bolt. With the remaining components being designed accordingly, it would therefore be entirely possible to prepare a jump take-off rotor head in accordance with the present invention which provides the resulting aircraft with a height dimension that is essentially the same as for the corresponding aircraft when fitted with a conventional fixed pitch rotor head.

When the rotor head is adapted to allow it to be fitted to certain types and models of autogyro, and which also utilise the same/same type of rotor blades, it is preferable to ensure that rotor head is designed such that the overall rotor diameter including the rotor blades remains largely unchanged. Preferably in these situations, the rotor head diameter after incorporating the rotor head of present invention should be within ±5% of the original rotor diameter, and more preferably within ±1% of the original rotor diameter. For an autogyro for instance, since there is no power provided to the main rotor in flight, the rpm of the rotor in flight changes during manoeuvres as it is constantly in equilibrium between the autorotative force of acceleration applied to the lower portion of the blades, in opposition to the drag forces that are applied particularly at the rotor tips. An increase if the overall rotor diameter for the same aircraft and loading therefore has the effect of reducing the average autorotative rotational rpm of the rotor blades in flight. Whilst a reduction of the overall rotor diameter has the effect of increasing the average autorotative rotational rpm of the rotor blades in flight. It is therefore generally preferred to maintain the overall diameter of the rotor blades within a certain tolerance, so as to ensure that the rotor rpm during more extreme manoeuvres remains within acceptable limits.

Further to the height and rotor diameter considerations as noted above, it would also be desirable to ensure that the rotors themselves are easy to remove. This is an important aspect of any autogyro as it facilitates the replacement of worn rotor blades, as well as for inspection purposes, and for providing an aircraft which can be stored and/or transported more easily. In accordance with the present invention it may therefore be desirable to also provide a simple means of disconnecting the collective pitch mechanism such that the rotor blades can be disconnected and removed from the aircraft with minimal time and effort. This could be achieved for instance by ensuring that the horn links (128) also comprise a quick release mechanism. This would then provide easy access to the teeter bolt so that the rotors can be removed from the aircraft.

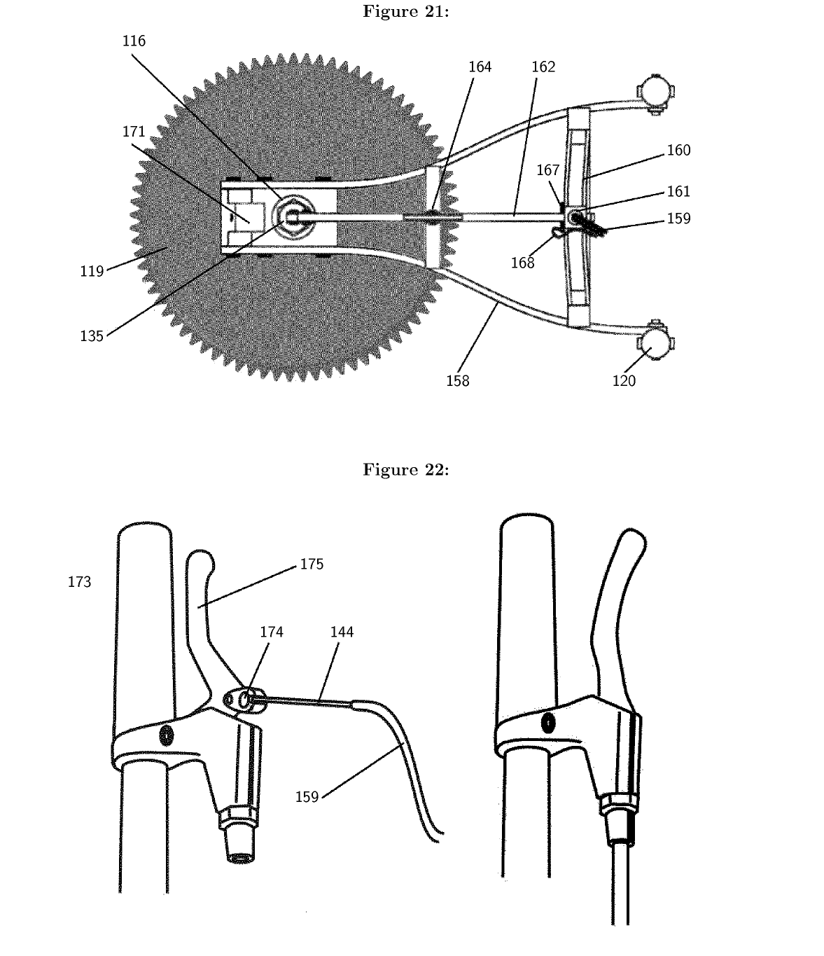

FIGS. 20 and 21 exemplify one of many possible alternatives by which a cable attachment means can be connected to the collective pitch mechanism of the present invention (the dashed lines as shown in FIG. 20, are used here merely to identify which parts of the mechanism would normally be hidden from view by the side of the rotor head control frame (158)). The cable housing (159) can be affixed to the rotor head control frame (158), at any suitable point, but which is preferably held in a rigid position by some suitable attachment means (160) and a cylindrical connector (161). The cable (144) itself being passed through the centre of a pitch leaver (162), with cable (144) being terminated with a secure fixing means (163). Pitch leaver (162) being able to pivot through a pivot point (164), which is secured to the rotor head control frame (158) through a secure fixing point (165). The end of the pitch leaver (162) which is opposite to the cable attachment point, being attached to the bottom of the internal pushrod (133) through a connective means (166) and bearing (143). The mechanism as shown in FIG. 20 also shows the lower pitch stop (135) and the bottom of spring bias means (124) and which is therefore consistent with an embodiment of the present invention as substantiated in FIG. 12. The presence of bearing (143) is necessary here in order to allow the rotor hub (125) and pushrod (133) to be able to rotate freely about the rotor axis.

Additionally FIG. 20 also shows how a suitable sensory means can be attached to the rotor head control frame (158) in order to provide some indication as to the operational state of the collective pitch mechanism of the invention. In accordance with FIG. 20, a suitable sensory means such as a micro-switch (167) can be attached to the rotor head control frame (158), and which may be provided with a flexible electrical cable (168). In the event that the sensory means includes an electrical cable (168) this can be passed directly to the airframe either through the mast (109) (not shown), or via one of the control rods (120). The cable means (159) and (144) can also be directed to the airframe in a similar manner. In use, and when the rotor blades are held at their minimised drag collective pitch angle (as represented here by position (A)); it is desirable that a section of pitch leaver (162) makes contact with said sensory means (167). When the pitch leaver (162) is in either position (B) or position (C), there should be no such contact. Such a sensory means such as a micro-switch can therefore be utilised in accordance with a suitable indicator light, or other suitable informative output media device, to provide the pilot with a real-time indication as to whether the pitch control mechanism has been successfully activated.

The mechanism exemplified in FIG. 20 also shows the possible attachment means for the rotor hub (125) to the rotor head control frame (158) which is mediated through a rotor head bearing (116), and bearing block (169). As discussed above and also with reference to FIG. 6, the pitch and roll of the aircraft can be mediated through a pair of control rods (120) which may be attached to the rotor head control frame (158) by suitable bearing means, such as a spherical bearing (170). The rotor head control frame of the present invention may also be attached to the mast of the rotorcraft through conventional means such as through a universal joint comprising a pair of perpendicular hinges (113) and (114), with the main aircraft mast (109) being attached to the mast plates (115). The universal joint hinges (113) and (114) are arranged to be perpendicular to each other such that the cyclic T-piece (171) enables the whole rotor head to be able to tilt in three dimensions relative to the masts longitudinal axis and to thereby provide a head pitch axis and a head roll axis, all of which is controlled through a control input which is mediated through the pair of control rods (120). Obviously the rotor head should be manufactured such that in operation, there would be no contact/fouling of the components of the collective pitch mechanism with the aircraft mast (109) and/or mast plates (115). As disclosed in FIG. 3 of EP2279943 for instance, an alternative universal joint arrangement may be used, preferentially so as to provide greater access to the bottom of the rotor hub. The universal joint arrangement could also be presented in a form which provides greater access to the bottom of the rotor hub, as well as providing a more typical attachment to the mast. It may therefore be desirable to fabricate the universal joint such that combines a lower pivot/joint hinge (114) largely correlates to that as shown in FIG. 3 (and FIG. 6), whilst the upper pivot/joint hinge (113) largely correlates to corresponding pivot as shown in FIG. 3 of EP2279943. In this way the lower pivot/joint hinge (114) could more easily be accommodated to fit the mast plates of commercially available makes and models of aircraft.

FIG. 20 also shows a rotor head which incorporates a rotor ring gear (119), which is an ideal way of enabling the rotor system of the present invention to be prerotated prior to take-off. Obviously when utilising a rotor ring gear (119), the rotor head control frame (158) should also provide a means of connecting the rotor ring gear (119) to a suitable prerotator mechanism. An attachment means for the prerotator mechanism is not shown in FIG. 20 simply for the sake of clarity, however such mechanisms are well-known in the art, and in practice, a rotor head control frame (158) such as that shown in FIG. 20 would normally incorporate such an attachment means, and wherein the gear of the prerotator mechanism can be configured to engage with rotor ring gear (119) at any suitable point around its circumference.

In operation, and again with reference to FIG. 20; representation (A) shows the mechanism in a state whereby the collective pitch of the rotor blades is held at the minimised drag collective pitch angle. Pitch leaver (162) is held in this position by spring bias means (124), which in turn maintains a certain amount of tension in the operation cable (144). When the collective pitch is to be operated, and operation cable (144) is pulled, this facilitates pitch leaver (162) to travel to its most extreme position as shown in representation (C). This movement of pitch lever (162) simultaneously pushes pushrod (133) up through the centre of the rotor hub (125) and thereby increasing the collective pitch of the rotor blades. Now assuming that the rotor blades are rotating at a speed which is greater than the activation point of the centrifugal pitch stop mechanism; the centrifugal pitch stop mechanism of the present invention will activate as soon as pushrod (133) travels up beyond the holding point mediated by said centrifugal pitch stop mechanism. However, irrespective of the rotor blades rotational speed and the activation state of the centrifugal pitch stop mechanism, the collective pitch of the rotor blades is determined only by the relative position of pushrod (133) and pitch bar (123). It is only when the pilot releases the control means and when the rotational speed of the rotor blades is greater than the activation point that the collective pitch mechanism of the invention locks the pitch of the rotor blades collectively to their predetermined flight pitch angle (as represented by position B). Starting from position (C); when the operation cable (144) is released, spring bias means (124) pushes pushrod (133) back out through the bottom of the rotor hub (125), taking pitch leaver (162) with it and simultaneously helping to draw back the operation cable (144). However, once the further progress of pushrod (133) is held up by the centrifugal pitch stop, pitch leaver (162) is also prevented from progressing any further. The operation cable (144) and its fixing means (163) however can continue back to their starting position on account of an addition spring bias means (172) which may be incorporated into the components of the operating lever. This results in the mechanism resembling the situation as shown in representation (B) of FIG. 20.

In FIG. 21, an alternative view of a similar mechanism as discussed above and presented in FIG. 20 is shown. The representation in FIG. 21 shows an underside view of the rotor head control frame (158). This representation when viewed in conjunction with the representations of FIG. 20, gives a better understanding as to how the operating cable (144) can be attached to the rotor head control frame (158). With the mast plates (115) removed, it is also easier to understand the function of cyclic T-piece (171). (171) allows the whole rotor head to pivot forwards and back through the pivot closest to the top and rotor ring gear (119) thus allowing the pitch of the rotorcraft to be controlled. It also allows the rotor head to pivot from side to side through the bottom pivot, thus allowing the roll of the rotorcraft to be controlled.

In FIG. 22, a simple operative handle/leaver mechanism (173) is exemplified. The collective pitch cable (144) should be attached through a suitable connecting means (174), which enables the cable to be pulled relative to the cable housing (159). Such an operative handle as substantiated in FIG. 22 is very similar to those customarily used for the braking mechanism on a bicycle for instance, and when used in conjunction with the present invention could easily be presented in the cockpit within easy reach of the pilot. In another embodiment of the invention, the mechanical leaver (173) itself could be of a type which is intended to be operated through a suitable electrical solenoid and/or electrical servo system or other suitable electronic means which could then be activated from the cockpit via a suitable electronic activation push switch or other suitable means. A solenoid activation means may require the use of one or more dampening means to reduce the stress transferred to the mechanical components of the collective pitch mechanism. In this context, it is equally possible and desirable to incorporate said electronic activation means into the rotor head itself (such as being directly attached to the rotor head control frame (158)), and therefore the presence of an activation cable is entirely optional. However if a cable mechanism is to be utilised which requires a lever mechanism, (173) should be so designed such that when the handle (175) is operated, it pulls cable (144) thus activating the collective pitch mechanism in a way as discussed above. In a further embodiment of the present invention, the handle itself includes a spring biased means (172), such that when the handle is release the spring returns the handle back to its original position. As discussed above, cable (144) can be attached to the pitch leaver (162) such that it retains a degree on independence (as shown for instance in representation (B) of FIG. 20). It is equally possible to design the cable attachment means of the operating handle/leaver mechanism to incorporate a degree of independence, in which case cable (144) can be fixably attached to pitch leaver (162). Either way, cable (144) should only be forcibly moved when the operative handle/leaver mechanism (175) is pulled and not when said handle/lever is released; this therefore enables the collective pitch mechanism to retain a degree of independence, and in accordance with the relative position of the pitch leaver (162).

Alternatively, rather than using a cable system, in an alternative and preferred embodiment of the present invention; the collective pitch mechanism is operated through a hydraulic or pneumatic means. In this way it is possible to utilise a pressurised gas or fluid to move the pushrod(s) (133)/(126) rather than requiring a cable mechanism. Such a system is particularly desirable due to its operative reliability, combined with the fact that such aircraft often already include a compressor in order to operate the prerotator and/or rotor brake hydraulically or pneumatically. Such a hydraulic or pneumatically operating system can also be controlled through one or more electronic activation switches which in effect control the operation of the collective pitch mechanism through a suitable means, such as by operating a series of valves which control gas/fluid pressure. In this way; compressed air for instance could suddenly be directed (upon activation of the collective pitch control activation switch) to drive the pushrod(s) (133)/(126) from the minimised drag collective pitch angle (A), through to the take-off pitch angle (C). When the collective pitch control activation switch is released, a release valve could be opened, which would subsequently enable the pushrod(s) (133)/(126) to retract to either the minimised drag collective pitch angle (A) or the predetermined flight pitch angle (B).

The simplicity by which the mechanism of the present invention can be operated also cannot be emphasised enough; to achieve a jump take-off as discussed above, the pilot simply needs to push the activation button (or pull the activation lever etc.) for the desired length of time and at the appropriate moment prior to releasing it; the rotor head mechanism of the present invention itself making the appropriate collective pitch response, and which is in accordance with the rotation speed of the rotor blades. For ultimate ease of use, the collective pitch control activation button may be located on the main flight control stick.

### Control Means and Warning Systems:

When parts of the control means are electronic, it should obviously incorporate some kind of power supply. Such a simple electronically operated mechanism also enables the pilot to be provided with a simple electronic activation push switch or other similar electrical activation switch. Such an activation switch or handle could therefore be presented/attached within the cockpit at any suitable point, including without limitation; attachment to the throttle lever, attachment to the main control stick, or attachment to the instrument panel. It is particularly preferred that said electrical activation switch is mounted onto the side of either the main control stick, or the throttle lever, and which may optionally include a protective cover which prevents its unintentional use during flight. Alternatively, it may be desirable to isolate the activation switch electronically by an additional switch so as to prevent it from being used during flight. In a preferred embodiment, it may be desirable to configure the electronic activation switch such that it is inoperable when two conditions are met: i) the rotor rpm is greater than the activation point/minimum rotational speed of the rotor blades that is required for flight (i.e. such as being greater than around 300 rpm or 320 rpm); and ii) the centrifugal pitch stop is already in its activated state (as determined by the afore mentioned sensory means (167)). In the context of radio controlled, and/or remotely piloted aircraft, it would of course be easy to operate said activation means through an electronic activation switch which is provided on the remote control means, and which transfers control to the aircraft through a system of servos as known in the art.

As mentioned above, when the pitch control mechanism of the present invention includes the afore mentioned sensory means (167), it would thus be possible to include within the cockpit an indicator/warning light which provides information about the pitch of the rotor blades. Furthermore, given that operative handle/leaver mechanism (173) can be positioned virtually anywhere on the aircraft as mediated through the flexible cable means (144) and (159), or flexible tubes operating upon a hydraulic/pneumatic principal, and which can also be made to operate by some suitable electrical means; the present invention therefore provides the first known collective pitch mechanism for a rotorcraft which can be operated through a simple electronic on/off type of push activation switch, and which does not require a swashplate. Moreover, it would also of course be possible to integrate said push activation switch and said indicator light within a single unit. In this way, the light could be set to be on only when the pitch of the rotor blades is set to the minimised drag collective pitch angle. Once the button is pushed and/or the handle (173) is pulled, the indicator/warning light would only go off when the mechanism is activated. If for instance the centrifugal plates (100) did not engage (say for instance due to a lack of rotor rpm), or else there was a electrical/cable failure, the pilot would instantly know from the warning light that the rotor pitch had not been increased as intended. Such a safety feature could therefore be paramount, and easily installed in accordance with the present invention.

In order to prevent excessive wear on the collective pitch mechanism, and also to ensure that the collective pitch mechanism is operated and activated correctly; in another embodiment of the present invention, the control means and/or the sensory means (167) could be coupled to the aircraft's rotor rpm gauge/sensor. In this way if the pilot attempts to operate the control means when the rotor rpm is above the deactivation point but below the activation point of the centrifugal pitch stop, an alarm could sound, and/or a warning light be activated, and/or the control means could be rendered inoperable. An alarm system would immediately alert the pilot not to attempt to take-off. If the pilot then disconnects the prerotator mechanism and allows the speed of the rotor blades to fall below the deactivation point, the mechanism can safely be reset to the minimised drag collective pitch angle (A), and the rotor blades prerotated again, and/or inspected for signs of wear and/or damage. In particular, it is preferable to ensure that the mechanism is fitted with a safety feature whereby the activation switch has a cut-out feature and is electronically prevented from being operated when the speed of the rotor blades lies between the deactivation point and activation point of the centrifugal pitch stop. Alternatively, and/or if the collective pitch mechanism is not fitted with a sensory means (167), the rotor rpm gauge could simply be marked with an area/indicator showing the known activation point and deactivation point of that particular centrifugal pitch stop.

When the control means is facilitated through an electrical activation switch, it may also be possible to provide the pilot with an electrical trim switch to control the maximum travel of the pushrod(s) (133)/(126). In this way instead of solely relying upon the upper pitch stop (135) for controlling the maximum pitch of the rotor blades through pitch bar (123), it would be possible to trim the maximum pitch angle of the rotor blades to be anywhere from their optimal flight characteristic pitch to the maximum pitch angle as determined by the pitch stop (135). Such a trim switch may therefore further facilitate the use of the collective pitch mechanism of the invention by making it more adaptable for use in landing the aircraft, and by in essence providing an additional pitch stop D, in addition to those designated by the relative positions A, B and C as shown in FIGS. 7, 8, 9 and 20. Such a trim switch is also useful for safely reducing the pitch of the rotor blades to the minimised drag collective pitch angle (A) after landing, but when the rotors are still turning at a relatively high speed.

### Kits:

It is also an aim of the present invention to provide the rotor head in the form of a kit, which comprises the key mechanical components of the rotor head. The kit for instance may comprise: a number of attachment means for each rotor blade (131), wherein at least one of the attachment means comprises a pitch horn (129); a feathering means comprising either a series of two or more bearings (154), or alternatively a torsion plate; one or more pushrods (133) and/or (126); a pitch bar (123); two or more centrifugal plates (100); two or more suitable weights (102) for said centrifugal plates, and/or a series of weights to help optimise the rotor head performance; a pitch stop (101) configured to engage with the centrifugal plates, and which also incorporates a connective means which enables it to be attached to the one or more pushrods; and a control means which comprises either an operative handle, an electrical activation switch or an electrical push activation switch. The kit may also optionally include a set of rotor blades. The precise dimensions and number of the above components will depend largely upon the model of aircraft to which the kit is intended to be fitted. It is particularly preferred however that a range of different kits be manufactured such that a kit may be produced for all of the major factory built autogyros that have been in production within at least the last decade. This includes a range of aircraft models designed and produced by the major manufacturers including Autogyro GmbH (including for instance the MTOsport, Cavalon and Calidus models), Magni Gyro (including the M14, M16, M18, M22, M24 models), Phenix Autogyro, Celier Aviation (especially the various models of the Xenon autogyro), Rotortec GmbH (including the various Cloud Dancer Models), Aero-Sport International (including the Kahu Autogyro models), ELA Aviacion (including the ELA 07, ELA 08 and ELA 09 models), Hummingbird Gyrocopter (including the various H1 models), Arrow Copter (particularly the AC20), Sport Copter International (including the Sport Copter models, Lightning and Vortex models), Groen Brothers Aviation etc. etc. It is particularly preferred that kits prepared in accordance with the present invention are factory fitted and/or installed only by suitably qualified engineers and technicians. Nonetheless, it may also be possible to manufacture kits which are accompanied by a detailed set of instructions, and which are intended to fall into the homebuild category; provided however that the updated aircraft is fully certified prior to use. Whilst such kits and rotor heads may need to incorporate a range of design modifications in order to be fully optimised for the model in question; any such trivial and/or obvious modifications would be readily understood and identified by a person skilled in the art, and should not therefore be seen to be deviating from the scope and spirit of the present invention and as defined in the claims of this specification.

### Uses of the Invention:

A rotorcraft fitted the a rotor head of the present invention will have the ability to land in confined spaces, especially in situations where there is minimal provision for a rolling take-off. An autogyro fitted with the rotor head of the present invention is therefore capable of landing and taking off from an area which would be unusable by a conventional fixed pitch autogyro. The ability to reset the collective pitch mechanism for jump take-off without needing to stop the rotor blades could also prove to be useful in certain situations. A rotorcraft fitted with the rotor head of the present invention could therefore find applications for purposes such as aerial photography; for specialist photography including the use of infra-red night vision and/or thermal imaging cameras; for filming, including for sports coverage, media or news applications; for advertising; for feature film productions; for police surveillance and/or law enforcement; for fire fighting; for event security monitoring; for scenic tours; for search and rescue operations, including for medical and/or patient transport; for agricultural applications, including crop spraying, animal herding or forest conservation; for land surveying, including for pipeline monitoring; electricity power cable management, and the maintenance and/or servicing thereof; or for industrial construction work.

Materials to be Utilised in Accordance with the Present Invention:

The rotor head of the present invention includes a range of different components that are subject to different stresses, and forces, moreover, some components such as the rotor blades may be intended to be flexible, whilst others need to be rigid and robust. Furthermore, given that the scope of the present invention is intended to cover rotor heads which are intended for larger 4 or 6 seater commercial aircraft, through to smaller single and two seater sports aircraft, as well as for scale models and radio controlled aircraft etc.; a wide variety of materials may be suitable dependent upon the particular situation and type of aircraft that is being manufactured. However, given that many of the components utilised on the present invention are subject to large forces and high rotational speeds, they should typically be manufactured to a very high standard of quality, with many of the components also being required to be carefully constructed and balanced. It also highly desirable that the components are finished to be both aesthetically pleasing as well as being light and aerodynamic. It is particularly important that the components of the rotor head are manufactured to be as light as is reasonably possible. Whilst the present invention may take advantage of using weights attached to the centrifugal plates, these weights should be as light as possible whilst still being able to perform their intended function. In particular, if the centrifugal plates are made from a strong and lightweight material (including materials such as carbon fibre, light weight metal alloys etc.) it may be possible to use longer plates which locate weights of smaller mass further from the centre of rotation and which thereby enables the overall weight of the rotor head to be kept to a minimum. In general, components of the present invention can be manufactured from a whole range of suitable materials, including composite materials, nanoparticle composite materials, wood, wood derivatives, carbon fibre, fibre glass, as well as suitable high performance plastics etc. It is also desirable that many of the components of the aircraft, and particularly the collective pitch mechanism comprise metals such as aluminium, titanium, magnesium, steel, copper, chromium, nickel, zinc, silver, gold, vanadium, manganese, iron, tin etc. Metal alloys such as brass, stainless steel, as well as alloys of vanadium, alloys of nickel, alloys of titanium and other light weight alloys such as those of magnesium are especially desirable. The use of plastic components may also be suitable for the construction of many of the components, and not just for the construction of parts for model aircraft. Any suitable plastic may be selected, based upon its availability and applicability to the component in question. Suitable plastics include for instance polyethylenes including high density polyethylene, branched polyethylenes, polypropylene, PTFE etc. PEEK including the various grades of TecaPEEK being especially preferred for many applications due to its light weight and exceptional durability and temperature resistance. For the rotor blades, composite materials, epoxy-resin, aluminium (including extruded aluminium), aluminium alloys, titanium, titanium alloys, magnesium alloys, PEEK and wood are particularly preferred. The present invention typically utilises several bearings, and these should typically be of the highest quality, and those which are intended for use in aviation use are particularly preferred.

In accordance with the above description and drawings, the various methods of utilising the rotor head of the present invention the are now described in detail:

### A. Pre-Flight Checks:

Before attempting to actively utilise the present invention in flight; the pilot is first advised to carry out the usual pre-flight checks, and which should also include ensuring that the pitch control mechanism is fully operable across its full range (i.e. it can move all the way from point A to point C and back again) when the rotor blades are not rotating. To this end, the pilot should first verify the position of the trim switch (if fitted) to ensure the full operation and travel of the pitch angle changing means. The pilot should then push and hold the activation switch of the control means (or pull the operative handle) whilst simultaneously visibly ensuring that both the warning light goes off (if fitted), and that the pitch of the rotor blades increases. Upon releasing the collective pitch control mechanism's activation switch or handle the pilot should then verify that the warning light again becomes illuminated, and that the collective pitch of the rotor blades changes back to the original/minimised drag collective pitch angle. At this point the aircraft should be ready for operation. This procedure ensures that the collective pitch control mechanism of the present invention is fully and safely operable, whilst also ensuring that the rotor blades (103) are set to the minimised drag collective pitch angle (as designated by point A in FIG. 7), ready to be charged for a jump take-off.

### B. Jump Take Off:

1) With the undercarriage wheel brakes applied, and the pitch of the rotor blades set to the minimised drag collective pitch angle; holding the main flight control stick fully forward, the rotor blades are prerotated to their desired takeoff speed using the autogyro's inbuilt prerotator mechanism. By using the autogyro's instrument panel the readiness of the autogyro for take-off can be determined. Once the speed of the rotor blades exceeds the known activation point of the centrifugal pitch stop, and is also greater than the minimum rotor speed needed for flight, the rotor blades will be sufficiently ‘charged’ to perform the intended take-off manoeuvre. Just prior to take-off, the rotational speed of the rotor blades should ideally range from 300 to 600 rpm, and which is preferably between 350 and 550 rpm, and which is more preferably between 400 and 525 rpm, and which may ideally be about 420 rpm.

2) At this point the prerotator mechanism (118) is now disengaged, and the main flight control stick can be eased backwards to a more centralised position. The collective pitch of the rotor blades can now be increased by the control means, such as by pushing the collective pitch control mechanism's activation switch or by pulling the operative handle. As the aircraft climbs, thrust should be applied via the propeller.

3) Now that flight has been achieved, the pilot can safely release the collective pitch control mechanism's activation switch/operative handle; thus allowing the rotor head of the invention to automatically reduce the pitch of the rotor blades collectively to a predetermined pitch angle which is suitable for sustained flight, and which is ideally the optimal flight characteristic pitch. From this point on, the rotorcraft can be flown exactly as a fixed pitch autogyro, ensuring that the wheel brakes have been released before landing.

C. Takeoff with Reduced Ground Roll:

1) With the undercarriage brakes applied, and the collective pitch of the rotor blades set at the minimised drag collective pitch angle (A); using the autogyro's inbuilt prerotator mechanism, the rotor blades are prerotated to their intended speed (ideally with the main flight control stick fully forward), said intended speed being above the activation point of the centrifugal pitch stop, but below the minimum rotor speed required for take-off.

2) Once the required rotor speed has been reached, the prerotator mechanism (118) should be disengaged, the main flight control stick can be eased backwards, and the pitch of the rotor blades increased collectively by control means. The activation switch/operating handle of the control means should then be held for around a second or so before being released. The indicator/warning light (if fitted) should then be off, indicating that the rotor blades collective pitch angle has successfully been locked at the predetermined pitch angle which is suitable for sustained flight (and which is ideally the optimal flight characteristic pitch).

3) With the brakes released, and thrust being applied via the propeller, a short take-off run can now be made which is analogous to that of a fixed pitch autogyro, but due to the use of the mechanism of the present invention, it takes less time and energy to prerotate the rotor blades.

Although the invention has been described in detail, for the purpose of illustration, it is understood that such detail is for that purpose and variations can be made therein by those skilled in the art without departing from the spirit and scope of the invention which is defined by the following claims.

What is claimed is:

1. A rotorcraft rotor head comprising: (i) two or more rotor blades and/or rotor blade attachment means, wherein said rotor blades and/or said rotor blade attachment means are rotatably attached to rotate about a rotor axis, and pivot through a flapping and/or teetering hinge, and have a pitch angle; (ii) pitch angle changing means for collectively changing said pitch angle; (iii) centrifugal pitch stop mechanism having an activation point and comprising one or more centrifugal plates; and (iv) control means for providing a control input to said pitch angle changing means; wherein said centrifugal pitch stop mechanism is configured to attain an activated state and to interact with said pitch angle changing means; wherein said activated state is attained when the rotational speed of said rotor blades and/or said rotor blade attachment means is greater than said activation point and when a control input is provided by said control means; and wherein said activation point is less than the minimum rotational speed of the rotor blades that is required for flying the rotorcraft.

2. A rotor head as defined in claim 1, wherein the activated state of said centrifugal pitch stop mechanism is configured to interact with said pitch angle changing means to facilitate and collectively maintain said pitch angle at a predetermined pitch angle B which is suitable for sustained flight of the rotorcraft, and wherein said predetermined pitch angle B which is suitable for sustained flight of the rotorcraft is preferably an optimal flight characteristic pitch angle.

3. A rotor head as defined in claim 2, wherein the pitch angle of all of the individual rotor blades can be set equally and collectively to said predetermined pitch angle B which is suitable for sustained flight; wherein said pitch angle B can be sustained throughout a 360 degree rotation about said rotor axis; and wherein said pitch angle B can be sustained independently of any motion which can be facilitated through said flapping and/or teetering hinge.

4. A rotor head as defined in claim 2, wherein irrespective of the rotational speed of said rotor blades and/or said rotor blade attachment means, said control means and said pitch angle changing means enable the pitch angle of said rotor blades and/or said rotor blade attachment means to be held at a collective pitch angle C, wherein said collective pitch angle C is greater than said predetermined pitch angle B, and preferably wherein said collective pitch angle C is optimised for take-off performance of the rotorcraft.

5. A rotor head as defined in claim 4, wherein said collective pitch angle C is between 2 and 15 degrees; and wherein said predetermined pitch angle B which is suitable for sustained flight of the rotorcraft is between 1.5 and 7 degrees.

6. A rotor head as defined in claim 1, wherein said control means and said pitch angle changing means enable the pitch angle of said rotor blades and/or said rotor blade attachment means to be set to a minimised drag collective pitch angle A which produces minimal drag upon rotation of the rotor blades.

7. A rotor head as defined in claim 1, wherein said rotor head is a semi-rigid rotor head which comprises two of said rotor blades and/or said rotor blade attachment means, and which pivot through a teetering hinge.

8. A rotor head as defined in claim 7, wherein said teetering hinge has an axis of rotation, and wherein said axis of rotation is either substantially perpendicular to the longitudinal axis of said rotor blades; or else said axis of rotation is not perpendicular to the longitudinal axis of said rotor blades and is offset from the longitudinal axis of said rotor blades by between 50 and 89 degrees.

9. A rotor head as defined in claim 1, wherein said pitch angle changing means comprises a feathering hinge, and wherein said feathering hinge may optionally further comprise one or more feathering hinge bearings and/or a torsion plate.

10. A rotor head as defined in claim 1, wherein said centrifugal plates are in the form of a weighted lever and which comprises one or more weights located towards the distal end of each centrifugal plate, and wherein said centrifugal pitch stop mechanism is configured to provide a deactivation point which is at 300 rpm or less.

11. A rotor head as defined in claim 1, wherein said activation point is configured to be between 100 rpm and 350 rpm.

12. A rotor head as defined in claim 1, which further comprises one or more pushrods which direct a control input from said control means to said pitch angle changing means; and wherein said control input is directed to said one or more pushrods preferably via either a cable mechanism, a lever mechanism, a hydraulic system, a pneumatic system, or a combination thereof.

13. A rotor head as defined in claim 1, wherein said rotor head further comprises a connective means for a prerotator mechanism.

14. A rotor head as defined in claim 13, wherein said prerotator mechanism is capable of accelerating the rotational speed of said rotor blades and/or said rotor blade attachment means to a speed in excess of 100 rpm.

15. A rotor head as defined in claim 1, wherein said control means comprises an operative handle, an electrical activation switch or an electrical push activation switch.

16. A rotor head as defined in claim 1, wherein the rotor head further comprises an electrical warning light such as a light emitting diode (LED), that provides information regarding the activated state of said centrifugal pitch stop mechanism.

17. A rotor head as defined in claim 1 which is in the form of a kit, and which may be accompanied by instructions that detail how the rotor head should be assembled and utilised; and wherein said kit may optionally include two or more rotor blades.

18. A rotor head as defined in claim 17, wherein said kit, comprises components which are specifically adapted to allow the rotor head to be fitted to certain types and models of autogyro.

19. A rotor head as defined in claim 1 which is an autogyro rotor head.

20. A rotorcraft or autogyro comprising at least one rotor head as defined in claim 1.

21. Use of a rotorcraft or autogyro as defined in claim 20 for aerial photography; for specialist photography including the use of infra-red night vision and/or thermal imaging cameras; for filming, including for sports coverage, media or news applications; for advertising; for feature film productions; for police surveillance and/or law enforcement; for fire fighting; for event security monitoring; for scenic tours; for search and rescue operations, including for medical and/or patient transport; for agricultural applications, including crop spraying, animal herding or forest conservation; for land surveying, including for pipeline monitoring; electricity power cable management, and the maintenance and/or servicing thereof; or for industrial construction work.

22. An autogyro comprising an airframe, mast, rudder, one or more engines mounted onto said airframe for providing a propulsion power plant, and rotor head being tiltably attached to said mast to tilt relative to the masts longitudinal axis and to thereby provide a head pitch axis and a head roll axis; said rotor head comprising: (i) two or more rotor blades, wherein said rotor blades are rotatably attached to rotate about a rotor axis, and pivot through a flapping and/or teetering hinge, and have a pitch angle; (ii) pitch angle changing means for collectively changing said pitch angle of said rotor blades; (iii) centrifugal pitch stop mechanism having an activation point and comprising one or more centrifugal plates; and (iv) control means for providing a control input to said pitch angle changing means; wherein said centrifugal pitch stop mechanism is configured to attain an activated state and to interact with said pitch angle changing means; wherein said activated state is attained when the rotational speed of said rotor blades is greater than said activation point and when a control input is provided by said control means; and wherein said activation point is less than the minimum rotational speed of said rotor blades that is required for flying the autogyro.

23. An autogyro as defined in claim 22, wherein said centrifugal pitch stop mechanism has an activated state which is configured to interact with said pitch angle changing means to facilitate and collectively maintain said pitch angle at a predetermined pitch angle B which is suitable for sustained flight of the autogyro, and wherein said predetermined pitch angle B which is suitable for sustained flight of the autogyro is preferably an optimal flight characteristic pitch angle.

24. An autogyro as defined in claim 23, wherein the pitch angle of all of the individual rotor blades can be set equally and collectively to said predetermined pitch angle B which is suitable for sustained flight; wherein said pitch angle B can be sustained throughout a 360 degree rotation about said rotor axis; and wherein said pitch angle B can be sustained independently of any motion which can be facilitated through said flapping and/or teetering hinge.

25. An autogyro as defined in claim 23, wherein irrespective of the rotational speed of said rotor blades, said control means and said pitch angle changing means enable the pitch angle of said rotor blades to be held at a collective pitch angle C, wherein said collective pitch angle C is greater than said predetermined pitch angle B, and preferably wherein said collective pitch angle C is optimised for take-off performance of the autogyro.

26. An autogyro as defined in claim 25, wherein said collective pitch angle C is between 2 and 15 degrees; and wherein said predetermined pitch angle B which is suitable for sustained flight of the autogyro is between 1.5 and 7 degrees.

27. An autogyro as defined in claim 22, wherein said control means and said pitch angle changing means enable the pitch angle of said rotor blades to be set to a minimized drag collective pitch angle A which produces minimal drag upon rotation of the rotor blades.

28. An autogyro as defined in claim 22, wherein said rotor head is a semi-rigid rotor head which comprises two of said rotor blades, and which pivot through a teetering hinge.

29. An autogyro as defined in claim 28, wherein said teetering hinge has an axis of rotation, and wherein said axis of rotation is either substantially perpendicular to the longitudinal axis of said rotor blades; or else said axis of rotation is not perpendicular to the longitudinal axis of said rotor blades and is offset from the longitudinal axis of said rotor blades by between 50 and 89 degrees.

30. An autogyro as defined in claim 22, wherein said pitch angle changing means comprises a feathering hinge, and wherein said feathering hinge may optionally further comprise one or more feathering hinge bearings and/or a torsion plate.

31. An autogyro as defined in claim 22, wherein said centrifugal plates are in the form of a weighted lever and which comprises one or more weights located towards the distal end of each centrifugal plate, and wherein said centrifugal pitch stop mechanism is configured to provide a deactivation point which is at 300 rpm or less.

32. An autogyro as defined in claim 22, wherein said activation point is configured to be between 100 rpm and 350 rpm.

33. An autogyro as defined in claim 22, wherein said rotor head further comprises one or more pushrods which direct a control input from said control means to said pitch angle changing means; and wherein said control input is directed to said one or more pushrods preferably via either a cable mechanism, a lever mechanism, a hydraulic system, a pneumatic system, or a combination thereof.

34. An autogyro as defined in claim 22, wherein said autogyro further comprises a prerotator mechanism, and wherein said prerotator mechanism preferably comprises: i) one or more gears which are connected to said engine through a power transmission means; or ii) one or more thrust means attached to said rotor blades, wherein said thrust means is facilitated through the use of a suitable rocket fuel, preferably through the decomposition of hydrogen peroxide.

35. An autogyro as defined in claim 34, wherein said prerotator mechanism is capable of accelerating the rotational speed of said rotor blades to a speed in excess of 100 rpm.

36. An autogyro as defined in claim 22, wherein said control means comprises an operative handle, an electrical activation switch or an electrical push activation switch.

37. An autogyro as defined in claim 22, wherein said autogyro further comprises: a first sensory means which enables the rotational speed of said rotor blades to be determined; and a second sensory means which enables the collective pitch angle of said rotor blades to be determined; and wherein said first sensory means and said second sensory means can be used in conjunction to provide an information and/or warning system.

38. An autogyro as defined in claim 22, wherein said autogyro further comprises an electrical warning light that provides information regarding the activated state of said centrifugal pitch stop mechanism, and wherein said electrical warning light is preferably a light emitting diode (LED).

39. A method of performing a vertical takeoff and flight manoeuvre in a rotorcraft or autogyro as defined in claim 20; said method comprising the steps of: 1) providing a control input to set the pitch angle of the rotor blades collectively to a minimised drag collective pitch angle A; 2) prerotating said rotor blades to a speed which is greater than the minimum rotational speed of the rotor blades that is required for flying the rotorcraft or autogyro; 3) providing a control input to increase the pitch angle of said rotor blades collectively to a pitch angle C so as to perform a vertical takeoff manoeuvre; and 4) removing said control input and thereby reducing the pitch angle of said rotor blades collectively to a pitch angle B which is suitable for flying the rotorcraft.

40. (canceled)
